(19) United States
(12) Patent Application Publication
(10) Pub. No.: US 2012/0207880 A1
(43) Pub. Date: Aug. 16, 2012

(54) GLUTEN ADDITIVES FOR RICE BAKERY AND PREPARATION METHOD THEREOF

(75) Inventors: Malshick Shin, Seoul (KR); Seung Hyun Lee, Gwangju (KR); Ji Myung Kim, Gwangju (KR)

(73) Assignee: INDUSTRY FOUNDATION OF CHONNAM NATIONAL UNIVERSITY, Gwangju (KR)

(21) Appl. No.: 13/502,679

(22) PCT Filed: Oct. 25, 2010
(86) PCT No.: PCT/KR10/07335

§ 371 Date: Apr. 18, 2012

(30) Foreign Application Priority Data
Oct. 23, 2009 (KR) 10-2009-0101107
Jan. 18, 2010 (KR) 10-2010-0004224
Jan. 18, 2010 (KR) 10-2010-0004225
Jan. 18, 2010 (KR) 10-2010-0004226
Oct. 23, 2010 (KR) 10-2010-0103747

(51) Int. Cl. A23L 1/10; A21D 13/08; A23G 3/48; A23L 1/16; A23L 1/105

(52) U.S. Cl. 426/61; 426/557; 426/558

(57) ABSTRACT

The present disclosure provides: (a) a composition for preparing gluten-free wet rice noodle, rice cake, baked rice confectionery, rice cookie and rice bread, (b) gluten-free wet rice noodle, rice cake, baked rice confectionery, rice cookie and rice bread, and (c) a method for preparing the same. The present disclosure not only provides superior gustatory sensation over wet wheat noodle, wheat cake, baked wheat confectionery, wheat cookie and wheat bread but also provides well-being diet cake for health improvement in terms of nutrition since intake of sugar and sweet substances as well as fats can be reduced. In addition, the present disclosure will find useful applications in the well-being health food industry and the agricultural processed food industry since wheat allergy can be avoided owing to the absence of wheat and the gluten-free food is of great help to patients with celiac disease or atopy.

### TECHNICAL FIELD

The present disclosure relates to gluten-free rice bakery and a method for preparing the same.

### BACKGROUND ART

The existing wheat bread is made from 100% wheat flour or from a flour mixture of wheat and other grains. The reason why wheat flour is used to make bread is because the prolamin or glutelin protein contained in wheat forms gluten and provides extensibility.

Rice contains about 7% of protein. However, since the protein is mostly glutenin not gluten, a desired extensibility is not achieved unlike the wheat flour. Hence, wheat flour is mixed with rice flour to make bread. But, the resulting bread is not rice bread, in a strict sense, but wheat-rice bread.

Korean Patent Registration No. 10-0345185 discloses a method of producing cake, baked confectionery or cookie from rice flour only by gelatinizing starch with lactic acid bacteria and fermenting the gelatinized rice flour. Although the resulting rice cake has increased volume and improved mouth feeling because of increased dough viscosity, the cake has a hard and brittle texture as well as a sticky chewing feeling like that of rice tteok.

Recently, there have been attempts to make rice bread by adding vital gluten extracted from wheat flour or gluten extracted from wheat to rice flour. However, excessive addition of gluten results in disappearance of the flavor of rice bread as well as health problems such as genetic allergy, celiac disease, etc.

When making wheat bread or wheat cake, a large quantity of sugar and fatty substances such as butter are used to add to flavor, which may cause severe health problems.

As such, wheat bakery as well-being health food has problems to be solved in terms of health care. In this regard, rice food may be an appropriate solution when considering that rice production surpasses rice consumption in Korea.

Accordingly, there is a need of new wet rice noodle, rice cake, baked rice confectionery, rice cookie and rice bread with considerably reduced sugar and fat contents and safe from diseases or disorders caused by the food additives vital gluten and gluten.

Throughout the specification, a number of publications and patent documents are referred to and cited. The disclosure of the cited publications and patent documents is incorporated herein by reference in its entirety to more clearly describe the state of the related art and the present disclosure.

### DISCLOSURE

The inventors of the present disclosure have made efforts to develop a novel composition for preparing rice noodle, rice cake, baked rice confectionery, rice cookie and rice bread having low calorie and being safe from diseases or disorders caused by the food additives vital gluten and gluten. As a result, they have found out that rice bread having a similar structure as that of wet wheat noodle, wheat cake, baked wheat confectionery, wheat cookie and wheat bread with strong flour added by mixing (i) nonglutinous rice, isolated soy protein and gum, (ii) rice flour, egg, sweet, salt, vegetable oil and fermented grain liquor, (iii) rice flour, butter, egg, sweet, baking powder and fermented grain liquor, (iv) rice flour, butter, egg, sweet, milk and dairy cream, or (v) rice flour, protein, sweet, salt, yeast, nonfat dry milk, vegetable oil, gum, transglutaminase and water at optimized proportions, even when strong flour is not added, without sacrificing taste, flavor and appearance qualities as compared to wet wheat noodle, wheat cake, baked wheat confectionery, wheat cookie and wheat bread.

The present disclosure is directed to providing a composition for preparing gluten-free wet rice noodle.

The present disclosure is also directed to providing gluten-free wet rice noodle.

The present disclosure is also directed to providing a method for preparing gluten-free wet rice noodle.

The present disclosure is also directed to providing a composition for preparing gluten-free rice cake.

The present disclosure is also directed to providing gluten-free rice cake.

The present disclosure is also directed to providing a method for preparing gluten-free rice cake.

The present disclosure is also directed to providing a composition for preparing gluten-free baked rice confectionery.

The present disclosure is also directed to providing gluten-free baked rice confectionery.

The present disclosure is also directed to providing a method for preparing gluten-free baked rice confectionery.

The present disclosure is also directed to providing a composition for preparing gluten-free rice cookie.

The present disclosure is also directed to providing gluten-free rice cookie.

The present disclosure is also directed to providing a method for preparing gluten-free rice cookie.

The present disclosure is also directed to providing a composition for preparing gluten-free rice bread.

The present disclosure is also directed to providing gluten-free rice bread.

The present disclosure is also directed to providing a method for preparing gluten-free rice bread.

Other features and aspects will be apparent from the following detailed description, drawings and claims.

In one general aspect, the present disclosure provides a composition for preparing gluten-free wet rice noodle.

The inventors of the present disclosure have made efforts to develop a novel composition for preparing rice noodle, rice cake, baked rice confectionery, rice cookie and rice bread having low calorie and being safe from diseases or disorders caused by the food additives vital gluten and gluten. As a result, they have found out that rice bread having a similar structure as that of wet wheat noodle, wheat cake, baked wheat confectionery, wheat cookie and wheat bread with strong flour added can be prepared by mixing (i) nonglutinous rice, isolated soy protein and gum, (ii) rice flour, egg, sweet, salt, vegetable oil and fermented grain liquor, (iii) rice flour, butter, egg, sweet, baking powder and fermented grain liquor, (iv) rice flour, butter, egg, sweet, milk and dairy cream, or (v) rice flour, protein, sweet, salt, yeast, nonfat dry milk, vegetable oil, gum, transglutaminase and water at optimized proportions, even when strong flour is not added, without sacrificing taste, flavor and appearance qualities as compared to wet wheat noodle, wheat cake, baked wheat confectionery, wheat cookie and wheat bread.

The present disclosure provides gluten-free wet rice noodle with excellent cooking quality without using wheat flour.

In the present disclosure, amylose-containing normal nonglutinous rice and high-amylose rice are screened, washed with water, immersed in water and then dried to obtain rice flour. Or, rice grain is dried at low temperature of 40° C. to water content of about 12%, milled and passed through a sieve of 80-160 mesh to obtain rice flour.

An exemplary process according to the present disclosure is schematically shown in FIG. 1.

In another general aspect, the present disclosure provides a composition for preparing gluten-free rice cake comprising 70-200 parts by weight of rice flour, 100-300 parts by weight of egg, 40-120 parts by weight of sweet, 5-40 parts by weight of vegetable oil, 0.1-3 parts by weight of salt and 5-40 parts by weight of fermented grain liquor.

The inventors of the present disclosure have made efforts to develop a novel composition for preparing rice cake having low calorie and being safe from diseases or disorders caused by vital gluten and gluten. As a result, they have found out that rice bread having the same volume as that of rice cake with weak flour added can be prepared by mixing rice flour, egg, sweet, salt, vegetable oil and fermented grain liquor at optimized proportions, even when weak flour and butter are not added, without sacrificing taste and appearance qualities as compared to wheat cake.

Confectionery such as cake, baked confectionery and cookie made from wheat flour has no special problem since the wheat flour contains gluten. However, since rice flour does not contain gluten, the ingredients and mixing proportions thereof as well as preparation process have to be changed from those of wheat confectionery.

The inventors of the present disclosure have scientifically designed and established a recipe for preparation of rice bakery products from rice flour. Then, they have designed, tested and established a process for preparing the rice bakery products.

The inventors of the present disclosure have established appropriate ingredients, mixing proportions thereof, i.e. recipe, and preparation process for preparation of rice bakery products from rice flour and confirmed the followings as compared to wheat flour products.

First, when preparing rice bakery products from rice flour, addition amount of liquid ingredients such as water (H₂O) and milk should be increased for complete gelatinization since the content of starch comprising amylose and amylopectin is about 80%.

Second, a long resting time is required for uniform water absorption since rice flour absorbs water slowly.

Third, since rice flour has a higher sugar content than wheat flour and a starch content of about 80%, sugar may not disperse uniformly when kneaded with water and remain freely without binding with gluten, resulting in sweeter taste and worse kneadability. Thus, addition amount of sweets such as sugar, starch syrup, etc. should be reduced by 20-50%.

Fourth, since rice flour is free from proteins that can bind with fats, such as gluten, fat may melt while the kneaded dough is baked. Thus, addition amount of butter, which is an animal fat, should be reduced.

In the present disclosure, vegetable oil is added to the composition, so that the vegetable oil may form complexes with the rice starch amylose during baking at the gelatinization temperature of amylose. As a result, rice cake with soft taste and stable structure can be provided.

In an exemplary embodiment of the present disclosure, the composition for preparing rice cake of the present disclosure may comprise 10-30 parts, more specifically 15-25 parts, most specifically 18-22 parts by weight of vegetable oil.

As used herein, the term “composition for preparing rice cake” refers to dough, solid or powder comprising the ingredients at specific proportions. For example, it means dough for preparing rice cake comprising the ingredients at optimized proportions.

As used herein, the term “gluten” refers to a natural protein composite contained in wheat, barely, etc., which is a sticky substance helping dough to expand. It is formed when wheat flour is kneaded with water. And, the term “vital gluten” refers to a protein formed from binding of the wheat proteins gliadin and glutenin. With high viscosity and elasticity, it gives the ability of holding carbon dioxide produced by fermentation, thus providing volume.

As used herein, the term “gluten-free” means that gluten is not included at all (0 wt %).

The present disclosure provides a composition for preparing rice cake which does not include gluten at all and hence does not cause diseases or disorders caused by intake of gluten such as indigestion, allergy and celiac disease.

A feature of the present disclosure is to use gluten-free rice flour.

That is to say, the rice flour used in the present disclosure is not the rice flour (dried at high temperature) commonly used to produce rice products but is prepared by immersing rice in water followed by drying, milling and drying at low temperature of 40° C. to protect starch particles from heat. The resulting gluten-free rice flour can be uniformly mixed with other ingredients and can easily absorb water necessary for gelatinization.

In an exemplary embodiment of the present disclosure, the rice flour used in the present disclosure is prepared by immersing rice in water for 2-15 hours, drying at low temperature of 5-35° C. and then milling, or by immersing rice in water for 2-15 hours, milling and then drying at low temperature of 5-35° C. More specifically, the rice flour is prepared by immersing rice in water for 2-15 hours, drying at low temperature of 5-35° C. and then milling.

Specifically, when rice is immersed in water before being milled into rice flour, the rice may be immersed in water for 3-12 hours, more specifically for 4-12 hours, further more specifically for 6-10 hours, most specifically for 7-9 hours.

Specifically, when rice or rice flour is dried at low temperature, the drying temperature may be 10-34° C., more specifically 20-33° C., further more specifically 25-32° C., most specifically 29-31° C.

In an exemplary embodiment of the present disclosure, the rice flour has a water content of 5-20%, more specifically 7-18%, further more specifically 9-16%, most specifically 11-14%.

The water content of rice flour may be measured using a moisture balance (Precisa 310M, Switzerland).

The particle size of the rice flour is selected such that desired water dispersibility can be obtained during the resting period following kneading of the rice flour with water. The inventors of the present disclosure have confirmed that rice flour passing through a sieve of 120-160 mesh is desirable when considering flavor, texture and volume of rice cake.

In an exemplary embodiment of the present disclosure, the rice flour has a particle size of 50-200 μm, more specifically 60-150 μm, most specifically 70-130 μm.

The rice flour may be prepared from any rice regardless of amylose content, species or degree of polishing, such as polished rice, brown rice, old rice, crushed rice, colored rice, germinated rice, etc.

In an exemplary embodiment of the present disclosure, the rice flour may be flour of one or more selected from a group consisting of glutinous rice, nonglutinous rice, brown rice, germinated brown rice and black rice, more specifically flour of one or more selected from a group consisting of glutinous rice, nonglutinous rice and brown rice, further more specifically flour of nonglutinous rice or brown rice, most specifically flour of nonglutinous rice.

In the composition of the present disclosure, the rice flour can be uniformly mixed with other ingredients even when gluten is not added owing to the optimized mixing proportions.

In an exemplary embodiment of the present disclosure, the composition for preparing rice cake of the present disclosure comprises 80-150 parts, more specifically 95-120 parts, most specifically 95-105 parts by weight of rice flour.

The composition of the present disclosure may comprise egg at optimized content for uniform mixing with other ingredients.

In an exemplary embodiment of the present disclosure, the composition for preparing rice cake of the present disclosure comprises 150-250 parts, more specifically 170-230 parts, further more specifically 190-210 parts, most specifically 195-205 parts by weight of egg.

The sweet used in the present disclosure may be any sweet-tasting substance or ingredient that can be used in food making, without particular limitation.

In an exemplary embodiment of the present disclosure, the sweet is one or more selected from a group consisting of sucrose, fructose, glucose, starch syrup, lactose, sorbitol, maltitol, lactitol, isomalt and xylitol, more specifically one or more selected from a group consisting of sucrose, fructose, glucose, starch syrup, lactose, sorbitol and xylitol, further more specifically one or more selected from a group consisting of sucrose, glucose, starch syrup and lactose, most specifically sucrose or starch syrup.

Since the composition of the present disclosure comprises the sweet in a minimal amount, production cost is decreased and diseases or disorders resulting from excessive sugar intake can be prevented.

In an exemplary embodiment of the present disclosure, the composition for preparing rice cake of the present disclosure comprises 50-100 parts, more specifically 60-90 parts, most specifically 75-85 parts by weight of sweet.

As used herein, the term “sun-dried salt” refers to salt mainly comprising sodium chloride crystals, obtained from solar evaporation of seawater at the salt farm. The term “refined salt” refers to salt obtained by dissolving sun-dried salt or rock salt in purified water or seawater, followed by filtration to remove impurities and recrystallization. The term “purified salt” refers to salt obtained by concentrating seawater via electrodialysis using ion-exchange membrane followed by drying, or by dissolving raw salt and then drying. The term “burnt/molten salt” refers to salt obtained by a repeated procedure of heating rock salt or sun-dried salt to high temperatures of 800° C. or above and crushing (e.g., bamboo salt or roasted salt). The term “processed salt” refers to salt obtained by adding other food or food additives to sun-dried salt, refined salt, purified salt or burnt/molten salt to improve nutrition or taste.

As used herein, the term “salt” means a substance or ingredient giving salty taste that can be used as food additive.

The salt that can be used in the composition for preparing rice cake of the present disclosure may be any salt used to make cake or used as food additive in the food industry, without limitation.

In an exemplary embodiment of the present disclosure, the salt used in the present disclosure is one or more selected from a group consisting of sun-dried salt, refined salt, purified salt, burnt/molten salt and processed salt, more specifically one or more selected from a group consisting of sun-dried salt, refined salt and purified salt, most specifically sun-dried salt.

Since the composition of the present disclosure comprises the salt in a minimal amount, production cost is decreased and diseases or disorders resulting from excessive salt intake can be prevented.

In an exemplary embodiment of the present disclosure, the composition for preparing rice cake of the present disclosure comprises 0.5-2 parts, more specifically 0.7-1.8 parts, most specifically 1-1.5 parts by weight of salt.

In the composition for preparing rice cake of the present disclosure, fermented grain liquor is added instead of water in order to prepare rice cake having volume and texture comparable to those of wheat cake.

In an exemplary embodiment of the present disclosure, the composition for preparing rice cake of the present disclosure comprises 10-30 parts, more specifically 15-25 parts, most specifically 18-22 parts by weight of fermented grain liquor.

In an exemplary embodiment of the present disclosure, the fermented grain liquor used in the present disclosure is one or more selected from a group consisting of makgeolli, dongdongju, cheongju, yakju and beer, more specifically cheongju or yakju, most specifically cheongju.

The composition for preparing rice cake of the present disclosure may be used to make various types of cake such as rice roll cake, rice chiffon cake and rice pound cake. Various additives known in the art may be further included to make such rice cake.

In an exemplary embodiment of the present disclosure, the rice cake of the present disclosure is rice cup cake, rice roll cake, rice chiffon cake, castella, steamed rice cake, rice cheesecake, rice sponge cake, muffin or rice pound cake.

In another general aspect, the present disclosure provides gluten-free rice cake comprising 70-200 parts by weight of rice flour, 100-300 parts by weight of egg, 40-120 parts by weight of sweet, 5-40 parts by weight of vegetable oil, 0.1-3 parts by weight of salt and 5-40 parts by weight of fermented grain liquor.

Since the rice cake is prepared using the above-described composition for preparing gluten-free rice cake, a detailed description thereof will be omitted to avoid unnecessary redundancy.

In another general aspect, the present disclosure provides a method for preparing gluten-free rice cake, comprising:

(a) mixing 100-300 parts by weight of egg, 40-120 parts by weight of sweet and 0.1-3 parts by weight of salt:

(b) mixing the mixture resulting from the step (a) with 70-200 parts by weight of rice flour, 5-40 parts by weight of vegetable oil and 5-40 parts by weight of fermented grain liquor and kneading; and

(c) heating the mixture dough resulting from the step (b) to 120-200° C. to prepare gluten-free rice cake.

The step (a) may be performed under heating or at room temperature. Specifically, the step (a) may be performed by heating in a water bath of specific temperature in order to uniformly mix the egg, sweet and salt and to form small and uniform air bubbles.

In an exemplary embodiment of the present disclosure, the step (a) comprises heating in a water bath of 35-50° C.

Specifically, in the step (b), the mixture resulting from the step (a) may be first mixed with rice flour and then with vegetable oil and fermented grain liquor. More specifically, the mixing with vegetable oil and fermented grain liquor may comprise first adding a predetermined amount of vegetable oil and fermented grain liquor to rice flour, forming dough and then adding the remaining amount of vegetable oil and fermented grain liquor.

In an exemplary embodiment of the present disclosure, the step (b) further comprises, after mixing the mixture dough prepared in the step (a) with rice flour, resting at 15-30° C. for 5-50 minutes, so that the rice flour can be uniformly mixed with the mixture dough.

More specifically, the step (b) further comprises, after mixing the mixture dough prepared in the step (a) with rice flour, resting at 15-30° C. for 10-30 minutes, further more specifically at 15-30° C. for 15-25 minutes, most specifically at 15-30° C. for 18-22 minutes, so that the rice flour can be uniformly mixed with the mixture dough.

In the step (c), the mixture dough resulting from the step (b) (i.e. the dough comprising egg, sweet, salt, rice flour, fermented grain liquor and vegetable oil) is heated in an oven preheated to 120-200° C. for 15-20 minutes.

In an exemplary embodiment of the present disclosure, the heating temperature in the step (c) is 130-190° C., more specifically 150-180° C.

When heating the mixture dough in the step (c), the upper and lower portions of the mixture dough may be heated at different temperatures.

In an exemplary embodiment of the present disclosure, when heating the mixture dough in the step (c), the upper portion is heated at 150-200° C. and the lower portion is heated at 100-180° C. More specifically, the upper portion is heated at 165-195° C. and the lower portion is heated at 130-170° C. Further more specifically, the upper portion is heated at 170-190° C. and the lower portion is heated at 140-160° C. Most specifically, the upper portion is heated at 175-185° C. and the lower portion is heated at 145-155° C.

Since the preparation method includes the method for preparing the composition for preparing gluten-free rice cake and further includes heating the resulting composition for preparing gluten-free rice cake, a detailed description thereof will be omitted to avoid unnecessary redundancy.

In another general aspect, the present disclosure provides a composition for preparing gluten-free baked rice confectionery comprising 70-200 parts by weight of rice flour, 20-150 parts by weight of butter, 70-200 parts by weight of egg, 20-100 parts by weight of sweet, 0.1-5 parts by weight of baking powder and 5-50 parts by weight of fermented grain liquor.

The inventors of the present disclosure have made efforts to develop a novel composition for preparing baked rice confectionery having low calorie and being safe from diseases or disorders caused by vital gluten and gluten. As a result, they have found out that baked rice confectionery having the same volume as that of baked rice confectionery with weak flour added can be prepared by mixing rice flour, butter, egg, sweet, baking powder and fermented grain liquor at optimized proportions, even when weak flour is not added, without sacrificing taste and appearance qualities as compared to baked wheat confectionery.

The term “baked confectionery” refers to bakery prepared by baking wheat flour-based dough with fruit juice added as sweetener in an oven, and includes madeleine, pain de singe, or the like. But, in the present specification, the term “baked rice confectionery” is used to refer to bakery prepared by baking rice dough with no wheat flour, weak flour, gluten or vital gluten included at all in an oven.

Confectionery such as cake, baked confectionery and cookie made from wheat flour has no special problem since the wheat flour contains gluten. However, since rice flour does not contain gluten, the ingredients and mixing proportions thereof as well as preparation process have to be changed from those of wheat confectionery.

The inventors of the present disclosure have scientifically designed and established a recipe for preparation of rice bakery products from rice flour. Then, they have designed, tested and established a process for preparing the rice bakery products.

The inventors of the present disclosure have established appropriate ingredients, mixing proportions thereof, i.e. recipe, and preparation process for preparation of rice bakery products from rice flour and confirmed the followings as compared to wheat flour products.

First, when preparing rice bakery products from rice flour, addition amount of liquid ingredients such as water (H₂O) and milk should be increased for complete gelatinization since the content of starch comprising amylose and amylopectin is about 80%.

Second, a long resting time is required for uniform water absorption since rice flour absorbs water slowly.

Third, since rice flour has a higher sugar content than wheat flour and a starch content of about 80%, sugar may not disperse uniformly when kneaded with water and remain freely without binding with gluten, resulting in sweeter taste and worse kneadability. Thus, addition amount of sweets such as sugar, starch syrup, etc. should be reduced by 20-50%.

Fourth, since rice flour is free from proteins that can bind with fats, such as gluten, fat may melt while the kneaded dough is baked. Thus, addition amount of butter, which is an animal fat, should be reduced.

In the present disclosure, butter is added in the composition in minimal amount, so that the butter may form complexes with the rice starch amylose during baking at the gelatinization temperature of amylose. As a result, baked rice confectionery with soft taste and stable structure can be provided. Instead of butter, margarine may be added with the same amount.

In an exemplary embodiment of the present disclosure, the composition for preparing baked rice confectionery comprises 50-100 parts, more specifically 70-90 parts, most specifically 75-85 parts by weight of butter.

As used herein, the term “composition for preparing baked rice confectionery” refers to dough, solid or powder comprising the ingredients at specific proportions. For example, it means dough for preparing baked rice confectionery comprising the ingredients at optimized proportions.

As used herein, the term “gluten” refers to a natural protein composite contained in wheat, barely, etc., which is a sticky substance helping dough to expand. It is formed when wheat flour is kneaded with water. And, the term “vital gluten” refers to a protein formed from binding of the wheat proteins gliadin and glutenin. With high viscosity and elasticity, it gives the ability of holding carbon dioxide produced by fermentation, thus providing volume.

As used herein, the term “gluten-free” means that gluten is not included at all (0 wt %).

The present disclosure provides a composition for preparing baked rice confectionery which does not include gluten at all and hence does not cause diseases or disorders caused by intake of gluten such as indigestion, allergy and celiac disease.

A feature of the present disclosure is to use gluten-free rice flour. That is to say, the rice flour used in the present disclosure is not the rice flour (dried at high temperature) commonly used to produce rice products but is prepared by immersing rice in water followed by drying, milling and drying at low temperature of 40° C. to protect starch particles from heat. The resulting gluten-free rice flour can be uniformly mixed with other ingredients and can easily absorb water necessary for gelatinization.

In an exemplary embodiment of the present disclosure, the rice flour used in the present disclosure is prepared by immersing rice in water for 2-15 hours, drying at low temperature of 5-35° C. and then milling, or by immersing rice in water for 2-15 hours, milling and then drying at low temperature of 5-35° C. More specifically, the rice flour is prepared by immersing rice in water for 2-15 hours, drying at low temperature of 5-35° C. and then milling.

Specifically, when rice is immersed in water before being milled into rice flour, the rice may be immersed in water for 3-12 hours, more specifically for 4-12 hours, further more specifically for 6-10 hours, most specifically for 7-9 hours.

Specifically, when rice or rice flour is dried at low temperature, the drying temperature may be 10-34° C., more specifically 20-33° C., further more specifically 25-32° C., most specifically 29-31° C.

In an exemplary embodiment of the present disclosure, the rice flour has a water content of 5-20%, more specifically 7-18%, further more specifically 9-16%, most specifically 11-14%.

The water content of rice flour may be measured using a moisture balance (Precisa 310M, Switzerland).

The particle size of the rice flour is selected such that desired water dispersibility can be obtained during the resting period following kneading of the rice flour with water. The inventors of the present disclosure have confirmed that rice flour passing through a sieve of 120-160 mesh is desirable when considering flavor, texture and volume of rice cake.

In an exemplary embodiment of the present disclosure, the rice flour has a particle size of 50-200 μm, more specifically 60-150 μm, most specifically 70-130 μm.

The rice flour may be prepared from any rice regardless of amylose content, species or degree of polishing, such as polished rice, brown rice, old rice, crushed rice, colored rice, germinated rice, etc.

In an exemplary embodiment of the present disclosure, the rice flour may be flour of one or more selected from a group consisting of glutinous rice, nonglutinous rice, brown rice, germinated brown rice and black rice, more specifically flour of one or more selected from a group consisting of glutinous rice, nonglutinous rice and brown rice, further more specifically flour of nonglutinous rice or brown rice, most specifically flour of nonglutinous rice.

In the composition of the present disclosure, the rice flour can be uniformly mixed with other ingredients even when gluten is not added owing to the optimized mixing proportions.

In an exemplary embodiment of the present disclosure, the composition for preparing baked rice confectionery of the present disclosure comprises 80-150 parts, more specifically 95-120 parts, most specifically 95-105 parts by weight of rice flour.

The composition of the present disclosure may comprise egg at optimized content for uniform mixing with other ingredients.

In an exemplary embodiment of the present disclosure, the composition for preparing baked rice confectionery of the present disclosure comprises 80-150 parts, more specifically 85-120 parts, further more specifically 90-100 parts, most specifically 95-105 parts by weight of egg.

The sweet used in the present disclosure may be any sweet-tasting substance or ingredient that can be used in food making, without particular limitation.

In an exemplary embodiment of the present disclosure, the sweet used in the present disclosure is one or more selected from a group consisting of honey, sucrose, fructose, glucose, starch syrup, lactose, sorbitol, maltitol, lactitol, isomalt and xylitol, more specifically one or more selected from a group consisting of honey, sucrose, fructose, glucose, starch syrup, lactose, sorbitol and xylitol, further more specifically one or more selected from a group consisting of honey, sucrose, glucose, starch syrup and lactose, most specifically one or more selected from a group consisting of honey and sucrose.

Since the composition of the present disclosure comprises the sweet in a minimal amount, production cost is decreased and diseases or disorders resulting from excessive sugar intake can be prevented.

In an exemplary embodiment of the present disclosure, the composition for preparing baked rice confectionery of the present disclosure comprises 30-90 parts, more specifically 55-80 parts, most specifically 60-70 parts by weight of sweet.

In the composition for preparing baked rice confectionery of the present disclosure, fermented grain liquor is added instead of water in order to prepare baked rice confectionery having volume and texture comparable to those of baked wheat confectionery.

In an exemplary embodiment of the present disclosure, the composition for preparing baked rice confectionery of the present disclosure comprises 10-45 parts, more specifically 20-34 parts, most specifically 25-35 parts by weight of fermented grain liquor.

In an exemplary embodiment of the present disclosure, the fermented grain liquor used in the present disclosure is one or more selected from a group consisting of makgeolli, dongdongju, cheongju, yakju and beer, more specifically cheongju or yakju, most specifically cheongju.

The composition for preparing baked rice confectionery of the present disclosure comprises baking powder as an ingredient to expand the dough.

In an exemplary embodiment of the present disclosure, the composition for preparing baked rice confectionery comprises 0.5-4 parts, more specifically 1-3 parts, most specifically 1.5-2.5 parts by weight of baking powder.

Since the composition of the present disclosure comprises butter in a minimal amount, calorie intake is decreased and diseases or disorders resulting from excessive animal fat intake can be prevented.

In an exemplary embodiment of the present disclosure, the composition for preparing baked rice confectionery comprises 40-130 parts, more specifically 60-100 parts, further more specifically 70-100 parts, most specifically 75-85 parts by weight of butter.

The composition for preparing baked rice confectionery of the present disclosure may be used to make various types of baked rice confectionery such as rice madeleine, rice financier and rice petit four. Various additives known in the art may be further included to make such baked rice confectionery.

In an exemplary embodiment of the present disclosure, the baked rice confectionery is rice madeleine, rice financier, rice petit four, rice dorayaki or rice stick brownie.

When the composition for preparing baked rice confectionery of the present disclosure is used to make rice madeleine, it may further comprise citron jam.

In an exemplary embodiment of the present disclosure, when the composition for preparing baked rice confectionery of the present disclosure is used to make rice madeleine, it may comprise 5-20 parts, more specifically 7-15 parts, more specifically 8-12 parts, most specifically 9-11 parts by weight of citron jam.

In another general aspect, the present disclosure provides gluten-free baked rice confectionery comprising 70-200 parts by weight of rice flour, 20-150 parts by weight of butter, 70-200 parts by weight of egg, 20-100 parts by weight of sweet, 0.1-5 parts by weight of baking powder and 5-50 parts by weight of fermented grain liquor.

Since the baked rice confectionery is prepared using the above-described composition for preparing gluten-free baked rice confectionery, a detailed description thereof will be omitted to avoid unnecessary redundancy.

In another general aspect, the present disclosure provides a method for preparing gluten-free baked rice confectionery, comprising:

(a) mixing 70-200 parts by weight of rice flour with 70-200 parts by weight of egg, 20-100 parts by weight of sweet, 0.1-5 parts by weight of baking powder and 5-50 parts by weight of fermented grain liquor and kneading:

(b) mixing the mixture dough resulting from the step (a) with 20-150 parts by weight of butter heated in a water bath at 35-55° C. temperature and kneading; and

(c) heating the mixture dough resulting from the step (b) to 120-200° C. to prepare gluten-free baked rice confectionery.

In an exemplary embodiment of the present disclosure, the temperature of heating in a water bath in the step (b) is 37-50° C., more specifically 38-47° C., further more specifically 40-45° C.

In an exemplary embodiment of the present disclosure, the step (b) further comprises, after mixing the mixture dough prepared in the step (a) with rice flour, resting at 15-30° C. for 5-50 minutes.

More specifically, the step (b) further comprises, after mixing the mixture dough prepared in the step (a) with rice flour, resting at 15-30° C. for 10-30 minutes, further more specifically at 15-30° C. for 15-25 minutes, most specifically at 15-30° C. for 18-22 minutes, so that the rice flour can be uniformly mixed with the mixture dough.

In the step (c), the mixture dough resulting from the step (b) (i.e. the dough comprising rice flour, butter, egg, sweet, baking powder and fermented grain liquor) is heated in an oven preheated to 120-200° C. for 15-20 minutes.

In an exemplary embodiment of the present disclosure, the heating temperature in the step (c) is 130-190° C., more specifically 150-180° C.

When heating the mixture dough in the step (c), the upper and lower portions of the mixture dough may be heated at different temperatures.

In an exemplary embodiment of the present disclosure, when heating the mixture dough in the step (c), the upper portion is heated at 150-200° C. and the lower portion is heated at 100-180° C. More specifically, the upper portion is heated at 165-195° C. and the lower portion is heated at 130-170° C. Further more specifically, the upper portion is heated at 170-190° C. and the lower portion is heated at 140-160° C. Most specifically, the upper portion is heated at 175-185° C. and the lower portion is heated at 145-155° C.

Since the preparation method includes the method for preparing the composition for preparing gluten-free baked rice confectionery and further includes heating the resulting composition for preparing gluten-free baked rice confectionery, a detailed description thereof will be omitted to avoid unnecessary redundancy.

In another general aspect, the present disclosure provides a composition for preparing gluten-free rice cookie comprising 70-200 parts by weight of rice flour, 5-80 parts by weight of butter, 5-70 parts by weight of egg, 5-60 parts by weight of sweet, 5-40 parts by weight of milk and 0-10 parts by weight of baking powder.

The inventors of the present disclosure have made efforts to develop a novel composition for preparing rice cookie having low calorie and being safe from diseases or disorders caused by vital gluten and gluten. As a result, they have found out that rice cookie having the same volume as that of rice cookie with weak flour added can be prepared by mixing rice flour, butter, egg, sweet, milk and dairy cream at optimized proportions, even when weak flour is not added, without sacrificing taste and appearance qualities as compared to wheat cake.

Confectionery such as cake, baked confectionery and cookie made from wheat flour has no special problem since the wheat flour contains gluten. However, since rice flour does not contain gluten, the ingredients and mixing proportions thereof as well as preparation process have to be changed from those of wheat confectionery.

The inventors of the present disclosure have scientifically designed and established a recipe for preparation of rice bakery products from rice flour. Then, they have designed, tested and established a process for preparing the rice bakery products.

The inventors of the present disclosure have established appropriate ingredients, mixing proportions thereof, i.e. recipe, and preparation process for preparation of rice bakery products from rice flour and confirmed the followings as compared to wheat flour products.

First, when preparing rice bakery products from rice flour, addition amount of liquid ingredients such as water (H₂O) and milk should be increased for complete gelatinization since the content of starch comprising amylose and amylopectin is about 80%.

Second, a long resting time is required for uniform water absorption since rice flour absorbs water slowly.

Third, since rice flour has a higher sugar content than wheat flour and a starch content of about 80%, sugar may not disperse uniformly when kneaded with water and remain freely without binding with gluten, resulting in sweeter taste and worse kneadability. Thus, addition amount of sweets such as sugar, starch syrup, etc. should be reduced by 20-50%.

Fourth, since rice flour is free from proteins that can bind with fats, such as gluten, fat may melt while the kneaded dough is baked. Thus, addition amount of butter, which is an animal fat, should be reduced.

As used herein, the term “composition for preparing rice cookie” refers to dough, solid or powder comprising the ingredients at specific proportions. For example, it means dough for preparing rice cookie comprising the ingredients at optimized proportions.

As used herein, the term “gluten” refers to a natural protein composite contained in wheat, barely, etc., which is a sticky substance helping dough to expand. It is formed when wheat flour is kneaded with water. And, the term “vital gluten” refers to a protein formed from binding of the wheat proteins gliadin and glutenin. With high viscosity and elasticity, it gives the ability of holding carbon dioxide produced by fermentation, thus providing volume.

As used herein, the term “gluten-free” means that gluten is not included at all (0 wt %).

The present disclosure provides a composition for preparing rice cookie which does not include gluten at all and hence does not cause diseases or disorders caused by intake of gluten such as indigestion, allergy and celiac disease.

A feature of the present disclosure is to use gluten-free rice flour.

That is to say, the rice flour used in the present disclosure is not the rice flour (dried at high temperature) commonly used to produce rice products but is prepared by immersing rice in water followed by drying, milling and drying at low temperature of 40° C. to protect starch particles from heat. The resulting gluten-free rice flour can be uniformly mixed with other ingredients and can easily absorb water necessary for gelatinization.

In an exemplary embodiment of the present disclosure, the rice flour used in the present disclosure is prepared by immersing rice in water for 2-15 hours, drying at low temperature of 5-35° C. and then milling, or by immersing rice in water for 2-15 hours, milling and then drying at low temperature of 5-35° C. More specifically, the rice flour is prepared by immersing rice in water for 2-15 hours, drying at low temperature of 5-35° C. and then milling.

Specifically, when rice is immersed in water before being milled into rice flour, the rice may be immersed in water for 3-12 hours, more specifically for 4-12 hours, further more specifically for 6-10 hours, most specifically for 7-9 hours.

Specifically, when rice or rice flour is dried at low temperature, the drying temperature may be 10-34° C., more specifically 20-33° C., further more specifically 25-32° C., most specifically 29-31° C.

In an exemplary embodiment of the present disclosure, the rice flour has a water content of 5-20%, more specifically 7-18%, further more specifically 9-16%, most specifically 11-14%.

The water content of rice flour may be measured using a moisture balance (Precisa 310M, Switzerland).

The particle size of the rice flour is selected such that desired water dispersibility can be obtained during the resting period following kneading of the rice flour with water. The inventors of the present disclosure have confirmed that rice flour passing through a sieve of 120-160 mesh is desirable when considering flavor, texture and volume of rice cake.

In an exemplary embodiment of the present disclosure, the rice flour has a particle size of 50-200 μm, more specifically 60-150 μm, most specifically 70-130 μm.

The rice flour may be prepared from any rice regardless of amylose content, species or degree of polishing, such as polished rice, brown rice, old rice, crushed rice, colored rice, germinated rice, etc.

In an exemplary embodiment of the present disclosure, the rice flour may be flour of one or more selected from a group consisting of glutinous rice, nonglutinous rice, brown rice, germinated brown rice and black rice, more specifically flour of one or more selected from a group consisting of glutinous rice, nonglutinous rice and brown rice, further more specifically flour of nonglutinous rice or brown rice, most specifically flour of nonglutinous rice.

In the composition of the present disclosure, the rice flour can be uniformly mixed with other ingredients even when gluten is not added owing to the optimized mixing proportions.

In an exemplary embodiment of the present disclosure, the composition for preparing rice cookie of the present disclosure comprises 80-150 parts, more specifically 95-120 parts, most specifically 95-105 parts by weight of rice flour.

Since the composition of the present disclosure comprises butter in a minimal amount, calorie intake is decreased and diseases or disorders resulting from excessive animal fat intake can be prevented.

In an exemplary embodiment of the present disclosure, the composition for preparing rice cookie comprises 10-70 parts, more specifically 20-60 parts, further more specifically 30-55 parts, most specifically 40-50 parts by weight of butter.

The composition of the present disclosure may comprise egg at optimized content for uniform mixing with other ingredients.

In an exemplary embodiment of the present disclosure, the composition for preparing rice cookie of the present disclosure comprises 10-60 parts, more specifically 20-50 parts, further more specifically 30-45 parts, most specifically 35-40 parts by weight of egg.

The sweet used in the present disclosure may be any sweet-tasting substance or ingredient that can be used in food making, without particular limitation.

In an exemplary embodiment of the present disclosure, the sweet used in the present disclosure is one or more selected from a group consisting of honey, sucrose, fructose, glucose, starch syrup, lactose, sorbitol, maltitol, lactitol, isomalt and xylitol, more specifically one or more selected from a group consisting of honey, sucrose, fructose, glucose, starch syrup, lactose, sorbitol and xylitol, further more specifically one or more selected from a group consisting of honey, sucrose, glucose, starch syrup and lactose, most specifically honey or starch syrup.

Since the composition of the present disclosure comprises the sweet in a minimal amount, production cost is decreased and diseases or disorders resulting from excessive sugar intake can be prevented.

In an exemplary embodiment of the present disclosure, the composition for preparing rice cookie of the present disclosure comprises 10-50 parts, more specifically 15-40 parts, further more specifically 20-35 parts, most specifically 25-30 parts by weight of sweet.

The composition of the present disclosure may comprise milk at optimized content for control of the degree of kneading.

In an exemplary embodiment of the present disclosure, the composition for preparing rice cookie of the present disclosure comprises 8-30 parts, more specifically 10-20 parts, further more specifically 10-15 parts, most specifically 12-14 parts by weight of milk.

The composition of the present disclosure may comprise dairy cream at optimized content for providing soft texture and taste of rice cookie.

In an exemplary embodiment of the present disclosure, the composition for preparing rice cookie of the present disclosure comprises 1-12 parts, more specifically 2-10 parts, further more specifically 3-8 parts, most specifically 4-6 parts by weight of dairy cream.

The composition for preparing rice cookie of the present disclosure may be used to make various types of cookie such as stick cookie, choco-stick cookie, rice senbei or rice manju. Various additives known in the art may be further included to make such rice cookie.

In an exemplary embodiment of the present disclosure, the rice cookie is stick cookie, choco-stick cookie, citron shell cookie, bamboo leaf rice cookie, sweet potato mosaic rice cookie, cinnamon rice cookie, rice marble cookie, rice tiramisu cookie, rice walnut cookie, rice cranberry cookie, bamboo leaf/shoot tuile, rice senbei or rice manju.

In an exemplary embodiment of the present disclosure, the cookie prepared according to the present disclosure may further comprise almond flour.

In an exemplary embodiment of the present disclosure, the composition further comprises 1-30 parts, more specifically 3-20 parts, further more specifically 5-10 parts, most specifically 7-9 parts by weight of almond flour.

In another general aspect, the present disclosure provides gluten-free rice cookie comprising 70-200 parts by weight of rice flour, 5-80 parts by weight of butter, 5-70 parts by weight of egg, 5-60 parts by weight of sweet, 5-40 parts by weight of milk and 0.5-15 parts by weight of dairy cream.

Since the rice cookie is prepared using the above-described composition for preparing gluten-free rice cookie, a detailed description thereof will be omitted to avoid unnecessary redundancy.

In another general aspect, the present disclosure provides a method for preparing gluten-free rice cookie, comprising:

(a) mixing 5-80 parts by weight of butter with 5-60 parts by weight of sweet to prepare cream;

(b) mixing the creamed mixture with 70-200 parts by weight of rice flour, 5-70 parts by weight of egg, 5-40 parts by weight of milk and 0.5-15 parts by weight of dairy cream and kneading; and

(c) heating the mixture dough resulting from the step (b) to 120-220° C. to prepare gluten-free rice cookie.

In the step (b), rice flour and egg are added to the creamed mixture of butter and sweet resulting from the step (a) and mixed slightly to prepare mixture dough.

Then, 5-40 parts by weight of milk is added to the mixture dough to control the degree of kneading and then dairy cream is added to obtain the final mixture dough.

In an exemplary embodiment of the present disclosure, the step (b) further comprises, after mixing the mixture dough prepared in the step (a) with rice flour, resting at 15-30° C. for 5-50 minutes, so that the rice flour can be uniformly mixed with the mixture dough.

More specifically, the step (b) further comprises, after mixing the mixture dough prepared in the step (a) with rice flour, resting at 15-30° C. for 10-30 minutes, further more specifically at 15-30° C. for 15-25 minutes, most specifically at 15-30° C. for 18-22 minutes, so that the rice flour can be uniformly mixed with the mixture dough.

In the step (c), the mixture dough resulting from the step (b) (i.e. the dough comprising egg, sweet, salt, rice flour, fermented grain liquor and vegetable oil) is heated in an oven preheated to 120-200° C. for 15-20 minutes.

In an exemplary embodiment of the present disclosure, the heating temperature in the step (c) is 130-190° C., more specifically 150-180° C.

When heating the mixture dough in the step (c), the upper and lower portions of the mixture dough may be heated at different temperatures.

In an exemplary embodiment of the present disclosure, when heating the mixture dough in the step (c), the upper portion is heated at 150-210° C. and the lower portion is heated at 100-200° C. More specifically, the upper portion is heated at 165-205° C. and the lower portion is heated at 130-190° C. Further more specifically, the upper portion is heated at 180-200° C. and the lower portion is heated at 150-180° C. Most specifically, the upper portion is heated at 185-195° C. and the lower portion is heated at 160-170° C.

Since the preparation method includes the method for preparing the composition for preparing gluten-free rice cookie and further includes heating the resulting composition for preparing gluten-free rice cookie, a detailed description thereof will be omitted to avoid unnecessary redundancy.

In another general aspect, the present disclosure provides a composition for preparing gluten-free rice bread comprising 70-200 parts by weight of rice flour, 1-15 parts by weight of sweet, 0.1-6 parts by weight of salt, 0.1-10 parts by weight of yeast, 0.001-10 parts by weight of nonfat dry milk, 1-15 parts by weight of vegetable oil, 0.001-0.1 part by weight of transglutaminase and 70-150 parts by weight of water.

The inventors of the present disclosure have made efforts to develop a novel composition for preparing rice bread having low calorie and being safe from diseases or disorders caused by vital gluten and gluten. As a result, they have found out that rice bread having structure similar to that of wheat bread with strong flour added can be prepared by mixing rice flour, sweet, salt, yeast, nonfat dry milk, vegetable oil, transglutaminase and water at optimized proportions, even when strong flour and butter (shortening) are not added, without sacrificing taste, flavor and appearance qualities as compared to wheat bread.

Bread, baguette and bagel made from wheat flour have no special problem since the wheat flour contains gluten. However, since rice flour does not contain gluten, the ingredients and mixing proportions thereof as well as preparation process have to be changed from those of wheat flour products.

The inventors of the present disclosure have scientifically designed and established a recipe for preparation of rice bread from rice flour. Then, they have designed, tested and established a process for preparing the rice bread.

The inventors of the present disclosure have established appropriate ingredients, mixing proportions thereof, i.e. recipe, and preparation process for preparation of rice bread from rice flour and confirmed the followings as compared to wheat flour products.

First, when preparing rice bread products from rice flour, addition amount of liquid ingredients such as water (H₂O) and milk should be increased for complete gelatinization since the content of starch comprising amylose and amylopectin is about 80%.

Second, a long resting time is required for uniform water absorption since rice flour absorbs water slowly.

Third, since rice flour is free from gluten unlike strong flour, enzyme-assisted crosslinking between rice proteins and binding with gelatinized amylose are required to enhance structure.

Fourth, since rice flour is free from proteins that can bind with fats, such as gluten, fat may melt while the kneaded dough is baked. Thus, addition amount of butter or shortening, which is a solid fat, should be reduced and liquid oil should be used.

As used herein, the term “composition for preparing rice bread” refers to dough, solid or powder comprising the ingredients at specific proportions. For example, it means dough for preparing rice bread comprising the ingredients at optimized proportions.

As used herein, the term “gluten” refers to a natural protein composite contained in wheat, barely, etc., which is a sticky substance helping dough to expand. It is formed when wheat flour is kneaded with water. And, the term “vital gluten” refers to a protein formed from binding of the wheat proteins gliadin and glutenin. With high viscosity and elasticity, it gives the ability of holding carbon dioxide produced by fermentation, thus providing volume.

As used herein, the term “rice bread” refers to gluten-free rice bread. It includes, for example, unsliced rice bread, rice baguette and steamed rice bread.

As used herein, the term “gluten-free” means that gluten is not included at all (0 wt %).

The present disclosure provides a composition for preparing rice bread which does not include gluten at all and hence does not cause diseases or disorders caused by intake of gluten such as indigestion, allergy and celiac disease.

A feature of the present disclosure is to use gluten-free rice flour.

That is to say, the rice flour used in the present disclosure is not the rice flour (dried at high temperature) commonly used to produce rice products but is prepared by immersing rice in water followed by drying, milling and drying at low temperature to protect starch particles from heat. The resulting gluten-free rice flour can easily absorb water necessary for gelatinization and crosslinking between rice flour proteins can occur easily.

In an exemplary embodiment of the present disclosure, the rice flour used in the present disclosure is prepared by immersing rice in water for 2-15 hours, drying at low temperature of 5-35° C. and then milling, or by immersing rice in water for 2-15 hours, milling and then drying at low temperature of 5-35° C. More specifically, the rice flour is prepared by immersing rice in water for 2-15 hours, drying at low temperature of 5-35° C. and then milling.

Specifically, when rice is immersed in water before being milled into rice flour, the rice may be immersed in water for 3-12 hours, more specifically for 4-12 hours, further more specifically for 6-10 hours, most specifically for 7-9 hours.

Specifically, when rice or rice flour is dried at low temperature, the drying temperature may be 10-34° C., more specifically 20-33° C., further more specifically 25-32° C., most specifically 29-31° C.

In an exemplary embodiment of the present disclosure, the rice flour has a water content of 5-20%, more specifically 7-18%, further more specifically 9-16%, most specifically 11-14%.

The water content of rice flour may be measured using a moisture balance (Precisa 310M, Switzerland).

The particle size of the rice flour is selected such that desired water dispersibility and network structure can be obtained during the resting period following kneading of the rice flour with water. The inventors of the present disclosure have confirmed that rice flour passing through a sieve of 120-160 mesh is desirable when considering flavor, texture and volume of rice bread.

In an exemplary embodiment of the present disclosure, the rice flour has a particle size of 50-200 μm, more specifically 60-150 μm, most specifically 70-130 μm.

The rice flour may be prepared from any rice regardless of species or degree of polishing, such as nonglutinous rice, brown rice, old rice, crushed rice, colored rice, germinated rice, etc.

In an exemplary embodiment of the present disclosure, the rice flour may be flour of one or more selected from a group consisting of nonglutinous rice, brown rice, germinated brown rice and black rice, more specifically nonglutinous rice or brown rice, most specifically flour of nonglutinous rice.

In the composition of the present disclosure, the rice flour can be uniformly mixed with other ingredients even when gluten is not added owing to the optimized mixing proportions.

In an exemplary embodiment of the present disclosure, the composition for preparing rice bread of the present disclosure comprises 80-150 parts, more specifically 95-120 parts, most specifically 95-105 parts by weight of rice flour.

The sweet used in the present disclosure may be any sweet-tasting substance or ingredient that can be used in food making, without particular limitation.

In an exemplary embodiment of the present disclosure, the sweet used in the present disclosure is one or more selected from a group consisting of sucrose, fructose, glucose, starch syrup, lactose, sorbitol, maltitol, lactitol, isomalt and xylitol, more specifically one or more selected from a group consisting of sucrose, fructose, glucose, starch syrup, lactose, sorbitol and xylitol, further more specifically one or more selected from a group consisting of sucrose, glucose, starch syrup and lactose, most specifically sucrose or starch syrup.

In an exemplary embodiment of the present disclosure, the composition for preparing rice bread of the present disclosure comprises 2-12 parts, more specifically 4-10 parts, most specifically 6-8 parts by weight of sweet.

As used herein, the term “sun-dried salt” refers to salt mainly comprising sodium chloride crystals, obtained from solar evaporation of seawater at the salt farm. The term “refined salt” refers to salt obtained by dissolving sun-dried salt or rock salt in purified water or seawater, followed by filtration to remove impurities and recrystallization. The term “purified salt” refers to salt obtained by concentrating seawater via electrodialysis using ion-exchange membrane followed by drying, or by dissolving raw salt and then drying. The term “burnt/molten salt” refers to salt obtained by a repeated procedure of heating rock salt or sun-dried salt to high temperatures of 800° C. or above and crushing (e.g., bamboo salt or roasted salt). The term “processed salt” refers to salt obtained by adding other food or food additives to sun-dried salt, refined salt, purified salt or burnt/molten salt to improve nutrition or taste.

As used herein, the term “salt” means a substance or ingredient giving salty taste that can be used as food additive.

The salt that can be used in the composition for preparing rice bread of the present disclosure may be any salt used to make bread or used as food additive in the food industry, without limitation.

In an exemplary embodiment of the present disclosure, the salt used in the present disclosure is one or more selected from a group consisting of sun-dried salt, refined salt, purified salt, burnt/molten salt and processed salt, more specifically one or more selected from a group consisting of sun-dried salt, refined salt and purified salt, most specifically sun-dried salt.

Since the composition of the present disclosure comprises the salt in a minimal amount, production cost is decreased and diseases or disorders resulting from excessive salt intake can be prevented.

In an exemplary embodiment of the present disclosure, the composition for preparing rice cake of the present disclosure comprises 0.2-4 parts, more specifically 0.5-3 parts, most specifically 1-2 parts by weight of salt.

In the present disclosure, vegetable oil is added to the composition at optimized content, so that the vegetable oil may form complexes with the rice starch amylose at the gelatinization temperature of amylose. As a result, rice bread with soft taste and stable structure can be provided. The vegetable oil used in the present disclosure may be any known vegetable oil that can be added when making bread. Typically, the vegetable oil may include olive oil, rice bran oil and corn oil, which are extracted from plants.

In an exemplary embodiment of the present disclosure, the vegetable oil used in the present disclosure is one or more selected from a group consisting of olive oil, rice bran oil, corn oil, canola oil, soybean oil and sunflower oil, more specifically one or more selected from a group consisting of olive oil, rice bran oil and canola oil, more specifically olive oil, rice bran oil or a mixture thereof, most specifically rice bran oil.

In an exemplary embodiment of the present disclosure, the composition for preparing rice bread of the present disclosure comprises 2-12 parts, more specifically 3-10 parts, further more specifically 4-8 parts, most specifically 5-7 parts by weight of vegetable oil.

The composition for preparing rice bread of the present disclosure comprises nonfat dry milk at optimized content.

In an exemplary embodiment of the present disclosure, the composition for preparing rice bread of the present disclosure comprises 0.001-8 parts, more specifically 1-7 parts, further more specifically 3-6 parts, most specifically 4-5 parts by weight of nonfat dry milk.

The composition for preparing rice bread of the present disclosure comprises yeast at optimized content for fermentation.

In an exemplary embodiment of the present disclosure, the composition for preparing rice bread of the present disclosure comprises 1-8 parts, more specifically 1.5-6 parts, further more specifically 2-5 parts, most specifically 3-4 parts by weight of yeast.

The composition for preparing rice bread of the present disclosure comprises transglutaminase at optimized content as protein-crosslinking enzyme.

In an exemplary embodiment of the present disclosure, the composition for preparing rice bread of the present disclosure comprises 0.005-0.08 part, more specifically 0.01-0.06 part, further more specifically 0.015-0.05 part, most specifically 0.02-0.04 part by weight of transglutaminase.

The composition for preparing rice bread of the present disclosure comprises water at optimized content for uniform kneading of rice flour.

In an exemplary embodiment of the present disclosure, the composition for preparing rice bread of the present disclosure comprises 80-140 parts, more specifically 90-130 parts, further more specifically 95-120 parts, most specifically 100-115 parts by weight of water.

The composition for preparing rice bread of the present disclosure may further comprise substances for improving (i) texture of rice bread such as hardness, cohesiveness, springiness, adhesiveness, chewiness and resilience and (ii) sensation of rice bread such as surface color, surface smoothness, air cell uniformity, volume, smell, hardness, adhesiveness, springiness, chewiness and softness.

In an exemplary embodiment of the present disclosure, the composition of the present disclosure comprises one or more additive selected from a group consisting of: (i) 0.1-5 parts by weight of protein comprising whey protein and rice protein; (ii) 0.01-1 part by weight of one or more alginate selected from a group consisting of sodium alginate, ammonium alginate, potassium alginate, calcium alginate and propylene glycol alginate; and (iii) 0.01-1 part by weight of one or more cellulose derivative selected from a group consisting of methyl cellulose, ethyl cellulose, hydroxyethylcellulose, hydroxypropyl cellulose, hydroxypropyl methylcellulose, hydroxypropyl methylcellulose phthalate, sodium carboxymethyl cellulose and cellulose acetate phthalate.

More specifically, the composition of the present disclosure comprises one or more additive selected from a group consisting of (i) 0.5-4 parts by weight of protein comprising whey protein and rice protein, (ii) 0.05-0.6 part by weight of one or more alginate selected from a group consisting of sodium alginate, ammonium alginate, potassium alginate, calcium alginate and propylene glycol alginate and (iii) 0.02-0.5 part by weight of one or more cellulose derivative selected from a group consisting of methyl cellulose, ethyl cellulose, hydroxyethylcellulose, hydroxypropyl cellulose, hydroxypropyl methylcellulose, hydroxypropyl methylcellulose phthalate, sodium carboxymethyl cellulose and cellulose acetate phthalate, further more specifically one or more additive selected from a group consisting of (i) 1-3 parts by weight of protein comprising whey protein and rice protein, (ii) 0.1-0.5 part by weight of one or more alginate selected from a group consisting of sodium alginate, ammonium alginate, potassium alginate, calcium alginate and propylene glycol alginate and (iii) 0.03-0.12 part by weight of one or more cellulose derivative selected from a group consisting of methyl cellulose, ethyl cellulose, hydroxyethylcellulose, hydroxypropyl cellulose, hydroxypropyl methylcellulose, hydroxypropyl methylcellulose phthalate, sodium carboxymethyl cellulose and cellulose acetate phthalate, most specifically one or more additive selected from a group consisting of (i) 1.5-2 parts by weight of protein comprising whey protein and rice protein, (ii) 0.2-0.4 part by weight of one or more alginate selected from a group consisting of sodium alginate, ammonium alginate, potassium alginate, calcium alginate and propylene glycol alginate and (iii) 0.05-0.1 part by weight of one or more cellulose derivative selected from a group consisting of methyl cellulose, ethyl cellulose, hydroxyethylcellulose, hydroxypropyl cellulose, hydroxypropyl methylcellulose, hydroxypropyl methylcellulose phthalate, sodium carboxymethyl cellulose and cellulose acetate phthalate.

Specifically, the alginate included in the composition of the present disclosure is sodium alginate, ammonium alginate or a mixture thereof, more specifically sodium alginate.

Specifically, the cellulose derivative included in the composition of the present disclosure is selected from a group consisting of methyl cellulose, ethyl cellulose, hydroxyethylcellulose and hydroxypropyl cellulose, more specifically hydroxyethylcellulose, hydroxypropyl cellulose or a mixture thereof, most specifically hydroxypropyl cellulose.

And, the composition of the present disclosure may further comprise substances for improving surface color and structure of rice bread and, loosening internal structure and reducing calorie.

In an exemplary embodiment of the present disclosure, the composition of the present disclosure further comprises 0.1-20 parts, more specifically 1-10 parts, further more specifically 3-8 parts, most specifically 4-6 parts by weight of gelatinized rice flour, gelatinized starch, glutinous rice flour or a mixture thereof based on 100 parts by weight of rice flour.

In another general aspect, the present disclosure provides gluten-free rice bread comprising 70-200 parts by weight of rice flour, 1-15 parts by weight of sweet, 0.1-6 parts by weight of salt, 0.1-10 parts by weight of yeast, 0.001-10 parts by weight of nonfat dry milk, 1-15 parts by weight of vegetable oil, 0.001-0.1 part by weight of transglutaminase and 70-150 parts by weight of water.

Since the rice bread is prepared using the above-described composition for preparing gluten-free rice bread, a detailed description thereof will be omitted to avoid unnecessary redundancy.

In another general aspect, the present disclosure provides a method for preparing gluten-free rice bread, comprising:

(a) mixing 70-200 parts by weight of rice flour, 1-15 parts by weight of sweet, 0.1-6 parts by weight of salt, 0.001-10 parts by weight of nonfat dry milk, 0.001-0.1 part by weight of transglutaminase and 70-150 parts by weight of water and resting:

(b) adding 0.1-10 parts by weight of yeast and 1-15 parts by weight of vegetable oil to the mixture resulting from the step (a) and fermenting; and

(c) baking the fermented mixture dough at 120-250° C. to prepare gluten-free rice bread.

In an exemplary embodiment of the present disclosure, the step (b) further comprises resting the mixture dough prepared in the step (a), so that the rice flour can be uniformly mixed with the mixture dough.

More specifically, the step (b) further comprises resting at 10-50° C. for 5-180 minutes, more specifically at 15-45° C. for 30-120 minutes, further more specifically at 25-35° C. for 45-80 minutes, most specifically at 28-32° C. for 55-65 minutes.

Then, the mixture dough is fermented at specific temperature for a predetermined time.

In an exemplary embodiment of the present disclosure, the step (b) comprises, after adding yeast and vegetable oil to the mixture dough, fermenting at 10-50° C. for 5-100 minutes, more specifically at 15-45° C. for 10-60 minutes, further more specifically at 20-30° C. for 20-30 minutes, most specifically at 23-27° C. for 24-26 minutes.

Specifically, the step (b) may be performed under relative humidity of 35-45%. More specifically, the step (b) may be performed under relative humidity of 38-42%.

The method of the present disclosure may comprise further fermenting in order to improve the degree of fermentation of rice bread.

In an exemplary embodiment of the present disclosure, the step (b) may further comprise putting the fermented mixture on a baking frame or pan and further fermenting.

In an exemplary embodiment of the present disclosure, the step (b) comprises further fermenting at 10-50° C. for 1-30 minutes, more specifically at 15-45° C. for 5-20 minutes, further more specifically at 20-30° C. for 7-15 minutes, most specifically at 23-27° C. for 9-12 minutes.

In the step (b), the further fermenting may be performed under relative humidity of 35-45%. More specifically, it may be performed under relative humidity of 38-42%.

In the step (c), the mixture dough resulting from the step (b) (i.e. the dough comprising rice flour, sweet, salt, nonfat dry milk, transglutaminase, water, yeast and vegetable oil) is heated in an oven preheated to 120-250° C. for 15-20 minutes.

When heating the mixture dough in the step (c), the upper and lower portions of the mixture dough may be heated at different temperatures.

In an exemplary embodiment of the present disclosure, when heating the mixture dough in the step (c), the upper portion is heated at 150-240° C. and the lower portion is heated at 140-200° C. More specifically, the upper portion is heated at 170-230° C. and the lower portion is heated at 150-190° C. Further more specifically, the upper portion is heated at 200-220° C. and the lower portion is heated at 160-185° C. Most specifically, the upper portion is heated at 205-215° C. and the lower portion is heated at 165-175° C.

Since the preparation method includes the method for preparing the composition for preparing gluten-free rice bread and further includes heating the resulting composition for preparing gluten-free rice bread, a detailed description thereof will be omitted to avoid unnecessary redundancy.

The features and advantages of the present disclosure may be summarized as follows:

(i) The present disclosure provides: (a) a composition for preparing gluten-free wet rice noodle, rice cake, baked rice confectionery, rice cookie and rice bread, (b) gluten-free wet rice noodle, rice cake, baked rice confectionery, rice cookie and rice bread, and (c) a method for preparing the same.

(ii) The present disclosure not only provides superior gustatory sensation over wet wheat noodle, wheat cake, baked wheat confectionery, wheat cookie and wheat bread but also provides well-being diet cake for health improvement in terms of nutrition since intake of sugar and sweet substances as well as fats can be reduced.

(iii) In addition, the present disclosure will find useful applications in the well-being health food industry and the agricultural processed food industry since wheat allergy can be avoided owing to the absence of wheat and the gluten-free food is of great help to patients with celiac disease or atopy.

### DESCRIPTION OF DRAWINGS

FIG. 1 schematically shows a process of preparing wet rice noodle according to the present disclosure.

FIG. 2 shows photographs of cooked rice noodle prepared from wet rice noodle according to the present disclosure with no alginic acid derivative added (samples 3, 11, 12 and 13).

FIG. 3 shows photographs of cooked rice noodle prepared from wet rice noodle according to the present disclosure with increased amount of alginic acid derivative.

FIG. 4 shows photographs of wet rice noodle prepared from a composition for preparing wet rice noodle according to the present disclosure with alginic acid derivative and xanthan gum added.

FIG. 5 shows photographs of cooked rice noodle prepared from wet rice noodle according to the present disclosure with alginic acid derivative and xanthan gum added.

FIG. 6 shows photographs of cooked rice noodle prepared from wet rice noodle according to the present disclosure using flour of nonglutinous rice of various species.

FIG. 7 shows photographs of cooked rice noodle prepared from wet rice noodle according to the present disclosure using flour of nonglutinous rice of various particle sizes.

FIG. 8 shows a photograph of rice cup cake prepared according to the present disclosure.

FIGS. 9a-9f show photographs of rice roll cake, steamed rice cake, rice cake, polished rice muffin, polished rice gugelhopf and polished rice pound cake prepared from a composition for preparing rice cake of the present disclosure.

FIG. 10 shows a photograph of polished rice citron madeleine prepared according to the present disclosure.

FIGS. 11a-11d show photographs of polished rice gingerbread, polished rice black tea financier, glutinous rice petit and polished rice bamboo leaf madeleine prepared from a composition for preparing baked confectionery according to the present disclosure.

FIG. 12 shows a photograph of rice choco-stick cookie prepared according to the present disclosure.

FIGS. 13a-13n show photographs of polished rice citron shell cookie, bamboo leaf rice cookie, polished rice stick cookie, mosaic rice cookie, cinnamon rice cookie, rice marble cookie, (star-)shaped cookie, polished rice tiramisu cookie, rice walnut cookie, polished rice cranberry cookie, bamboo leaf/shoot tuile, brown rice senbei, sesame senbei and polished rice manju prepared from a composition according to the present disclosure.

FIG. 14 schematically shows a process of preparing gluten-free rice bread according to the present disclosure.

FIG. 15 shows photographs of gluten-free rice bread prepared using different additive. RB1 is rice bread prepared by mixing rice flour with sweet, salt, yeast, nonfat dry milk, vegetable oil and water (control), RB2 is rice bread prepared by mixing rice flour with sweet, salt, yeast, nonfat dry milk, vegetable oil and transglutaminase, RB3 is rice bread prepared by mixing rice flour with sweet, salt, yeast, nonfat dry milk, vegetable oil, transglutaminase and protein, RB4 is rice bread prepared by mixing rice flour with sweet, salt, yeast, nonfat dry milk, vegetable oil, transglutaminase, protein and alginic acid derivative, and RB5 is rice bread prepared by mixing rice flour with sweet, salt, yeast, nonfat dry milk, vegetable oil, transglutaminase, protein, alginic acid derivative and hydroxypropyl methylcellulose.

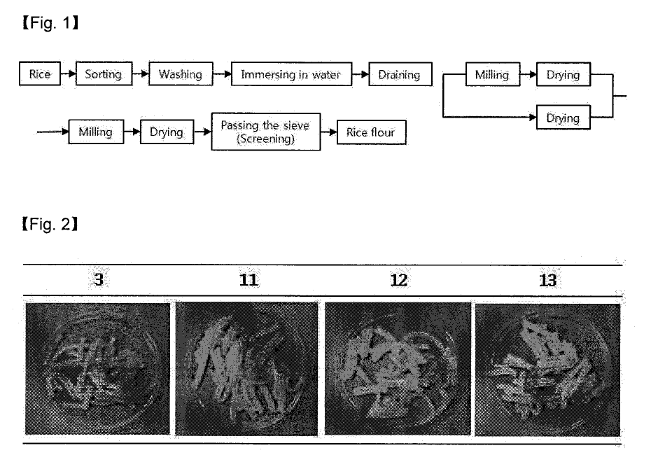

### BEST MODE

Hereinafter, the embodiments of the present disclosure will be described in detail with reference to the following examples. The following examples are for illustrative purposes only and those skilled in the art that will appreciate that they are not intended to limit the scope of the present disclosure.

Throughout the specification, “%” used to refer to the concentration of specific substance is (weight/weight) % for solid/solid, (weight/volume) % for solid/liquid and (volume/volume) % for liquid/liquid, unless specified otherwise.

### Example 1

### Preparation of Wet Rice Noodle

Wet rice noodle was prepared with different compositions of protein, gum, water and enzyme as shown in Tables 1-3.

Wet rice noodle was prepared by mixing rice flour with protein, preparing dough by adding gum, salt and water, resting at 40° C. for 1 hour, passing through a noodle-making machine 5-6 times, and cutting into noodle of regular size.

TABLE 1

| Sample | Rice flour | Soybean | | | |
|---|---|---|---|---|---|
| No. | (g) | protein (g) | Gum-A (g) | Salt (g) | Water (mL) |
| 1 | 91.37 | 4 | 0.4 | 2 | 54.13 |
| 2 | 91.37 | 0 | 0.2 | 2 | 51.63 |
| 3 | 91.37 | 0 | 0 | 2 | 54.13 |
| 4 | 91.37 | 4 | 0.2 | 2 | 51.63 |
| 5 | 91.37 | 0 | 0.2 | 2 | 56.63 |
| 6 | 91.37 | 2 | 0.4 | 2 | 51.63 |
| 7 | 91.37 | 2 | 0.2 | 2 | 54.13 |
| 8 | 91.37 | 2 | 0.4 | 2 | 56.63 |
| 9 | 91.37 | 4 | 0.2 | 2 | 56.63 |
| 10 | 91.37 | 0 | 0.4 | 2 | 54.13 |
| 11 | 91.37 | 2 | 0 | 2 | 56.63 |
| 12 | 91.37 | 4 | 0 | 2 | 54.13 |
| 13 | 91.37 | 2 | 0 | 2 | 51.63 |

(Note) Gum-A: alginic acid derivative

Dough for preparing wet rice noodle was prepared by mixing rice flour and additives with hot water and kneading at room temperature with hands for 10 minutes. The resulting dough was wrapped to prevent drying and packed to prevent air inflow, and rested for formation of stabilized structure. Then, the dough was prepared into 3 mm-thick sheet by repeatedly passing through a manual noodle-making machine (Pastabike 150, Italy), which was then cut to 5 mm-wide wet noodle. The prepared rice noodle was put in a reclosable bag and kept in a refrigerator.

Water content necessary for preparing rice flour into noodle was determined, and the effect of protein, enzyme and gum was investigated in Comparative Examples 1-3 as shown in Table 2.

TABLE 2

| Sample | Rice flour | Soybean | Enzyme | | | Water |
|---|---|---|---|---|---|---|
| No. | (g) | protein (g) | (g) | Gum (g) | Salt (g) | (mL) |
| 1-1 | 91.37 | 0 | 0 | 0.2 | 2 | 54.13 |
| 1-2 | 91.37 | 0 | 0 | 0.4 | 2 | 54.13 |
| 1-3 | 91.37 | 0 | 0 | 0.6 | 2 | 54.13 |
| 2-1 | 91.37 | 2 | 0 | 0.2 | 2 | 54.13 |
| 2-2 | 91.37 | 2 | 0 | 0.4 | 2 | 54.13 |
| 2-3 | 91.37 | 2 | 0 | 0.6 | 2 | 54.13 |
| 3-1 | 91.37 | 2 | 0.1 | 0.2 | 2 | 54.13 |
| 3-2 | 91.37 | 2 | 0.1 | 0.4 | 2 | 54.13 |
| 3-3 | 91.37 | 2 | 0.1 | 0.6 | 2 | 54.13 |

### Comparative Example 1

Noodle was prepared by only adding gum of different contents to rice flour.

### Comparative Example 2

Noodle was prepared by adding gum of different contents to rice flour, with given content of protein.

### Comparative Example 3

Noodle was prepared by adding gum of different contents to rice flour, with given contents of protein and enzyme.

The quality of prepared noodle was evaluated mechanically and sensationally.

### Comparative Example 4

A comparative test was carried out under the condition described in Table 3 in order to investigate the effect of different gums on the quality of wet rice noodle.

TABLE 3

| | Rice flour | Soybean | Gum-X | Gum-A | Water | |
|---|---|---|---|---|---|---|
| Sample | (g) | protein (g) | (g) | (g) | (mL) | Salt (g) |
| A | 94.4 | 3 | 0.3 | 0.3 | 60 | 2 |
| B | 94.7 | 3 | 0.3 | | 60 | 2 |
| C | 94.7 | 3 | | 0.3 | 60 | 2 |
| D | 95 | 3 | | | 60 | 2 |

1) Values with different superscripts in the same column are significantly different at p < 0.05
2) Gum-X: xanthan gum; Gum-A: alginic acid derivative

### Test Example 1

### Quality of Wet Noodle

Physical Properties of Noodle

L, a and b values of wet rice noodle prepared with different mixing proportions was measured using a colorimeter. Compression test and tensile test were carried out using a texture analyzer (TA-XT, England) for measurement of physical properties of the prepared noodle.

Cooking Quality of Noodle

Wet rice noodle (10 g) was added to boiling water (200 mL) and cooked for 5 minutes. The cooked noodle was weighed and volume increase was measured after putting the noodle in a measuring cylinder holding water. Water absorption was measured by measuring weight increase after cooking of the wet rice noodle. Cooking loss was calculated by transferring cooking water to an aluminum container, drying in an oven of 105° C. and measuring weight after drying.

Weight of the cooked noodle was measured after cooling the cooked noodle for 30 seconds with cold running water and removing water for 3 minutes on a cooking sieve.

Volume of the cooked noodle was measured by immersing the noodle in a 50-mL measuring cylinder holding 30 mL of distilled water.

Water absorption of the cooked noodle was calculated as follows.

Water absorption (%)=[Weight of cooked noodle(W₁)−Weight of wet noodle(W₀)]/Weight of wet noodle(W₀)×100

Cooking loss, which is the weight of solid released from the wet noodle during cooking, was determined by measuring weight after drying the cooking water in an oven of 105° C. for 12 hours.

Sensation of Cooked Noodle

Sensation of the wet rice noodle was tested by 13 panels who were told of the features of the wet rice noodle and trained for evaluation. They were asked to score from 1 to 9 points for gloss, color, flavor, hardness, chewiness, springiness and adhesiveness. Also, degree of cooking (well-done or underdone) and overall quality were evaluated as preference items. The cooked noodle (5 g) was held in a covered container and provided for evaluation.

Statistical Analysis

All test results were statistically treated using SAS package (Version 9.1) and analyzed by ANOVA and Duncan's multiple range test.

Test Result for Wet Rice Noodle

Screening Test 1

In order to establish the kind and content of additives and preparation method for improving structure, texture and cooking qualities of wet rice noodle, the inventors carried out tests for different rice flour, protein, water content and gum contents.

Qualities of Cooked Rice Noodle

The result of testing the qualities of cooked noodle is shown in Table 4. Water absorption of the cooked noodle was highest in sample 1. The noodle with no alginic acid derivative added showed low water absorption and was broken easily. When alginic acid derivative was not added, addition of soy protein resulted in increased water absorption. However, the noodle did not show structural integrity. Thus, it was confirmed that alginic acid derivative is a necessary additive in the preparation of wet rice noodle. The reason why sample 11 showed the lowest water absorption during cooking may be because the dough itself already contained a lot of water. Accordingly, it seems that the kind and properties of additive greatly affect the formation of dough. Sample 1 with the highest additive content had the largest volume. Sample 3 and 11 with low soy protein content and no alginic acid derivative added had small volume. Thus, it was confirmed that the gum additive plays an important role in during noodle formation and cooking through water absorption.

TABLE 4

| Sample | Water absorption (%) | Volume (mL) of | Cooking |
|---|---|---|---|
| No. | of cooked noodle | cooked noodle | loss (g) |
| 1 | 61.74 ± 3.66^{a} | 14.33 ± 0.58^{a} | 0.61 ± 0.07^{bcd} |
| 2 | 56.93 ± 0.65^{ab} | 14.00 ± 0.00^{ab} | 0.69 ± 0.03^{abcd} |
| 3 | 41.10 ± 1.84^{de} | 12.17 ± 0.29^{d} | 0.92 ± 0.05^{ab} |
| 4 | 53.65 ± 2.58^{bc} | 13.50 ± 0.00^{bc} | 0.83 ± 0.11^{abcd} |
| 5 | 58.00 ± 3.85^{ab} | 12.50 ± 0.00^{d} | 0.48 ± 0.11^{d} |
| 6 | 54.38 ± 6.18^{abc} | 14.33 ± 0.58^{a} | 0.59 ± 0.02^{bcd} |
| 7 | 53.50 ± 3.75^{bc} | 13.67 ± 0.58^{ab} | 0.71 ± 0.03^{abcd} |
| 8 | 55.52 ± 0.24^{ab} | 13.33 ± 0.29^{bc} | 0.50 ± 0.02^{d} |
| 9 | 55.16 ± 4.86^{ab} | 13.83 ± 0.29^{ab} | 0.71 ± 0.08^{abcd} |
| 10 | 58.80 ± 3.30^{ab} | 14.00 ± 0.00^{ab} | 0.56 ± 0.08^{cd} |
| 11 | 40.16 ± 4.47^{e} | 12.33 ± 0.29^{d} | 0.88 ± 0.13^{abc} |
| 12 | 52.44 ± 5.52^{bc} | 13.50 ± 0.50^{bc} | 0.91 ± 0.07^{ab} |
| 13 | 47.44 ± 5.06^{cd} | 12.83 ± 0.58^{cd} | 0.97 ± 0.14^{a} |

1) Values with different superscripts in the same column are significantly different at p < 0.05.

The result of measuring mechanical texture of the cooked noodle is shown in Table 5. Sample 10 showed the highest, statistically significant hardness. Thus, the condition with no soy protein added, alginic acid derivative added at highest content and water at intermediate content was determined as optimal condition for preparing dough for noodle.

Samples 1, 6 and 8 also showed high hardness. Since all of them contained alginic acid derivative at the highest content, the required content of the alginic acid derivative could be expected. From a preliminary experiment in which alginic acid derivative and xanthan gum and guar gum were used, it was confirmed that the alginic acid derivative and xanthan gum are important in formation of the noodle structure. Further study on the content will be necessary.

Adhesiveness was high in samples 12, 13 and 11. Thus, it is considered that high adhesiveness is achieved when alginic acid derivative is not added regardless of the addition of soy protein. High adhesiveness is not considered a good property when eating noodle. Springiness was significantly high in sample 1 and significantly low in samples 11 and 12. It is thought that addition of alginic acid derivative is the most important factor and the addition amount of water when soy protein is added is also relevant.

Cohesiveness was significantly high in samples 8 and 10 and low in samples 3 and 13. Gumminess and chewiness were statistically the highest in sample 8 and very low in samples 12 and 13. This trend suggests that when wet rice noodle is prepared by adding water, soy protein and alginic acid derivative, the contents of alginic acid derivative and water have larger effect than that of soy protein. Resilience representing the overall texture of noodle may be used as an index indicating the possibility of preparation into wet rice noodle. Under the described experiment condition, noodle formation was possible when resilience was 0.15 or larger and good noodle formation was achieved when resilience was about 0.20. To conclude, it was confirmed that the texture quality is the most affected by the content of gum and varies with the water content.

TABLE 5

| Sample | | | | | | | |
|---|---|---|---|---|---|---|---|
| No. | Hardness | Adhesiveness | Springiness | Cohesiveness | Gumminess | Chewiness | Resilience |
| 1 | 1716.5 ± 106.19^{a} | −7.51 ± 2.33^{ab} | 0.74 ± 0.05^{a} | 0.49 ± 0.0^{c} | 844.35 ± 84.15^{b} | 631.32 ± 94.45^{b} | 0.24 ± 0.02^{b} |
| 2 | 1476.66 ± 108.14^{c} | −17.67 ± 5.7^{d} | 0.66 ± 0.04^{c} | 0.44 ± 0.04^{e} | 644.24 ± 84.24^{de} | 428.31 ± 69.97^{d} | 0.17 ± 0.03^{d} |
| 3 | 1001.89 ± 67.83^{f} | −19.85 ± 3.9^{de} | 0.46 ± 0.03^{e} | 0.34 ± 0.03^{g} | 343.28 ± 45.76^{gh} | 158.23 ± 29.68^{f} | 0.12 ± 0.01^{e} |
| 4 | 1567.40 ± 101.48^{b} | −13.59 ± 2.75^{c} | 0.66 ± 0.03^{c} | 0.46 ± 0.01^{d} | 720.57 ± 37.31^{c} | 476.21 ± 32.96^{c} | 0.20 ± 0.01^{c} |
| 5 | 1264.21 ± 132.19^{e} | −4.19 ± 1.54^{a} | 0.63 ± 0.04^{d} | 0.43 ± 0.02^{e} | 548.35 ± 76.01^{f} | 345.12 ± 58.28^{e} | 0.20 ± 0.01^{c} |
| 6 | 1725.15 ± 90.40^{a} | −8.25 ± 2.09^{b} | 0.72 ± 0.03^{ab} | 0.51 ± 0.30^{b} | 881.56 ± 6.36^{ab} | 635.96 ± 64.95^{ab} | 0.24 ± 0.02^{b} |
| 7 | 1354.76 ± 84.26^{d} | −12.59 ± 2.92^{c} | 0.66 ± 0.03^{c} | 0.46 ± 0.01^{d} | 626.16 ± 38.74^{e} | 412.87 ± 35.15^{d} | 0.20 ± 0.01^{c} |
| 8 | 1709.30 ± 107.79^{a} | −6.08 ± 1.35^{ab} | 0.74 ± 0.03^{ab} | 0.53 ± 0.01^{a} | 912.72 ± 61.72^{a} | 671.41 ± 47.21^{a} | 0.26 ± 0.01^{a} |
| 9 | 1445.35 ± 112.03^{c} | −13.30 ± 2.77^{c} | 0.66 ± 0.02^{c} | 0.47 ± 0.02^{d} | 680.82 ± 66.37^{cd} | 446.52 ± 49.76^{cd} | 0.21 ± 0.01^{c} |
| 10 | 1733.74 ± 130.02^{a} | −7.70 ± 1.66^{ab} | 0.72 ± 0.02^{b} | 0.52 ± 0.01^{a} | 909.80 ± 73.90^{a} | 652.98 ± 45.09^{ab} | 0.26 ± 0.01^{a} |
| 11 | 875.24 ± 75.23^{g} | −22.90 ± 6.08^{e} | 0.43 ± 0.03^{f} | 0.35 ± 0.01^{fg} | 303.94 ± 30.38^{h} | 129.64 ± 19.73^{f} | 0.11 ± 0.01^{e} |
| 12 | 865.37 ± 52.58^{g} | −33.34 ± 6.50^{f} | 0.43 ± 0.04^{f} | 0.35 ± 0.02^{g} | 299.42 ± 31.12^{h} | 128.40 ± 23.37^{f} | 0.11 ± 0.01^{e} |
| 13 | 991.68 ± 122.85^{f} | −31.84 ± 11.57^{f} | 0.45 ± 0.03^{ef} | 0.36 ± 0.02^{f} | 356.78 ± 43.14^{g} | 161.11 ± 27.52^{f} | 0.11 ± 0.01^{e} |

1) Values with different superscripts in the same column are significantly different at p < 0.05.

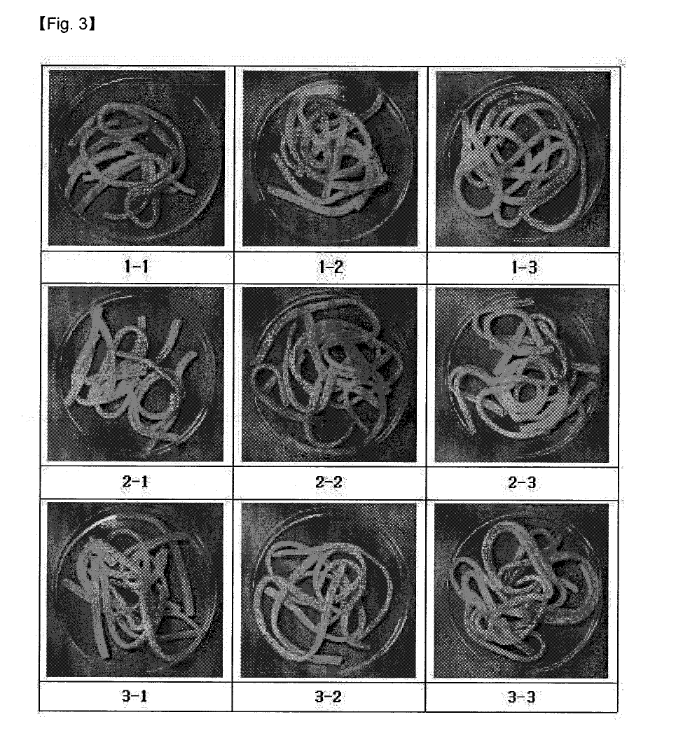

Samples 3, 11, 12 and 13 with no alginic acid derivative added were excluded from the test because wet rice noodle could not be prepared. The samples excluded from the sensation test are shown in FIG. 2. As seen from FIG. 2, the samples with no gum added did not form noodle but were broken. Accordingly, it is thought that the gum plays an important role in the preparation of wet noodle.

The result of sensation test excluding the above samples is shown in Table 6. Gloss was significantly high in sample 10 and lowest in sample 5. Significant difference was observed in color depending on the addition amount of soy protein. The color value was the highest in sample 10 wherein soy protein was not added and the content of alginic acid derivative was high. It seems that yellowish color of noodle results from the soy protein. Hardness was the highest in sample 5 and low in samples 1 and 4, coinciding with the mechanical measurement result. Gumminess and chewiness were highest in samples 5 and 1 and significantly low in sample 4.

Texture quality obtained from the sensation test showed difference from the mechanical measurement using TA. When alginic acid derivative is added, it is thought that the texture quality in the mouth is affected by water and soy protein contents. Preference for overall quality was the highest for the wet rice noodle with no soy protein added and with alginic acid derivative and water added at intermediate contents. Among the additives screened from the preliminary experiment, alginic acid derivative was confirmed to be a necessary ingredient. Further experiment was conducted to establish a condition for improving the quality of wet noodle. The possibility of noodle formation, water absorption cooking and cooking loss were important for wet rice noodle, and high springiness, chewiness, cohesiveness and resilience as well as low adhesiveness were important for cooked noodle.

TABLE 6

| | | | | | | | | Degree of | Overall |
|---|---|---|---|---|---|---|---|---|---|
| | Gloss | Color | Flavor | Hardness | Chewiness | Springiness | Adhesiveness | Cooking | preference |
| 1 | 5.62 ± 1.19^{bcd} | 4.00 ± 1.47^{d} | 5.31 ± 2.25 | 5.46 ± 1.05^{d} | 5.85 ± 1.63^{abc} | 6.38 ± 1.56^{a} | 3.92 ± 1.61 | 5.62 ± 2.06 | 4.85 ± 1.68^{b} |
| 2 | 6.46 ± 1.76^{ab} | 7.38 ± 1.26^{ab} | 5.62 ± 1.33 | 5.77 ± 1.01^{cd} | 5.54 ± 1.13^{bc} | 5.15 ± 1.68^{abc} | 4.00 ± 1.29 | 5.92 ± 1.55 | 5.62 ± 1.12^{ab} |
| 4 | 5.00 ± 1.22^{cd} | 4.54 ± 1.23^{d} | 5.85 ± 0.69 | 5.62 ± 1.39^{d} | 5.15 ± 1.57^{c} | 4.23 ± 1.69^{c} | 4.38 ± 1.97 | 5.31 ± 1.75 | 4.38 ± 1.56^{b} |
| 5 | 4.77 ± 1.54^{d} | 6.54 ± 1.20^{bc} | 5.31 ± 1.55 | 7.46 ± 1.56^{a} | 6.85 ± 1.57^{a} | 5.62 ± 2.14^{abc} | 4.69 ± 1.75 | 4.85 ± 1.52 | 4.92 ± 1.93^{b} |
| 6 | 6.08 ± 1.32^{abc} | 6.15 ± 1.72^{c} | 4.92 ± 1.85 | 5.85 ± 1.41^{bcd} | 5.85 ± 1.46^{abc} | 4.62 ± 1.26^{bc} | 4.23 ± 1.83 | 6.08 ± 1.89 | 5.77 ± 1.42^{ab} |
| 7 | 5.77 ± 1.17^{bcd} | 6.62 ± 1.39^{bc} | 6.46 ± 1.45 | 6.15 ± 1.41^{bcd} | 5.92 ± 1.12^{abc} | 4.92 ± 1.66^{abc} | 3.31 ± 1.49 | 5.54 ± 1.56 | 5.62 ± 1.61^{ab} |
| 8 | 6.23 ± 1.09^{ab} | 6.15 ± 1.14^{c} | 6.15 ± 1.21 | 6.92 ± 1.38^{ab} | 6.62 ± 1.19^{ab} | 6.31 ± 1.80^{a} | 3.62 ± 1.19 | 5.69 ± 1.25 | 5.77 ± 1.48^{ab} |
| 9 | 5.00 ± 1.35^{cd} | 4.23 ± 1.74^{d} | 5.00 ± 1.58 | 6.08 ± 1.25^{bcd} | 6.15 ± 1.28^{abc} | 4.92 ± 1.61^{abc} | 3.92 ± 1.75 | 5.23 ± 1.83 | 4.92 ± 1.19^{b} |
| 10 | 7.15 ± 1.28^{a} | 7.92 ± 1.04^{a} | 6.00 ± 1.15 | 6.77 ± 1.17^{abc} | 6.62 ± 1.04^{ab} | 6.08 ± 1.61^{ab} | 3.54 ± 1.81 | 6.31 ± 1.38 | 6.54 ± 1.66^{a} |

1) Values with different superscripts in the same column are significantly different at p < 0.05.

Test 2

As a result of the screening test, good noodle quality was achieved when 59.2% of water, 2% of isolated soy protein-S and 0.4% of gum were added to rice flour. As shown in Table 2, sample group 1 was prepared with no isolated soy protein-S added and sample group 2 was prepared with 2% isolated soy protein added, with varying gum contents of 0.2, 0.4 and 0.6%, in order to investigate the effect of each additive. The reason why isolated soy protein-S was used is because rice flour lacks structure-forming proteins such as gluten and has low protein content. In an experiment using the protein-crosslinking enzyme transglutaminase (TGase), the protein was found to form crosslinkages and thus provide improved network and texture. The enzyme was expected to modify the protein and improve processability during noodle formation. TGase is an enzyme that catalyzes the transfer of acyl group between the γ-carboxylamine group of the glutamine residue of protein or peptide and various primary amine groups, forming ε-(γ-glutamyl)lysine crosslinkage within or between proteins and polymerizing the proteins. Through amine coupling, crosslinking or deamination, the protein has improved functional properties including thermal stability, solidibility, emulsifiability, gel formability, hydratability, solubility, etc. The enzyme is expected to prevent thermal denaturation of the protein during cooking of the rice noodle to some extent. Thus, sample group 3 with the isolated soy protein-S and the enzyme added was prepared to investigate the effect of the addition of the enzyme on noodle.

Color of Wet Noodle

Color values of the wet noodle is shown in Table 7. Lightness (L) value was significantly high in the group with no soy protein added and low in sample 3-2 with the enzyme added. Redness (+a) was high in sample 2-1, indicating that isolated soy protein-S affects redness (+a). Yellowness (+b) was high in samples 2-3, 3-1 and 3-2, indicating that the color of wet noodle is affected a lot by the isolated soy protein-S but not by the enzyme or alginic acid derivative. Considering that the color noodle greatly affects the consumers' decision, use of the isolated soy protein-S in large amount is undesired. A content of about 2% seems appropriate.

TABLE 7

Hunter color values

| Sample | L | a | b |
|---|---|---|---|
| 1-1 | 89.86 ± 0.13^{b} | −0.60 ± 0.02^{e} | 6.23 ± 0.04^{e} |
| 1-2 | 90.22 ± 0.08^{a} | −0.57 ± 0.02^{d} | 6.15 ± 0.09^{e} |
| 1-3 | 90.19 ± 0.17^{a} | −0.61 ± 0.02^{e} | 6.36 ± 0.09^{d} |
| 2-1 | 89.24 ± 0.27^{c} | −0.47 ± 0.02^{a} | 8.03 ± 0.04^{c} |
| 2-2 | 89.12 ± 0.33^{cd} | −0.50 ± 0.01^{bc} | 8.12 ± 0.11^{bc} |
| 2-3 | 89.08 ± 0.16^{cd} | −0.50 ± 0.03^{bc} | 8.30 ± 0.09^{a} |
| 3-1 | 88.86 ± 0.27^{de} | −0.51 ± 0.03^{c} | 8.27 ± 0.20^{a} |
| 3-2 | 88.72 ± 0.13^{e} | −0.49 ± 0.01^{abc} | 8.29 ± 0.05^{a} |
| 3-3 | 89.04 ± 0.15^{cd} | −0.48 ± 0.01^{ab} | 8.19 ± 0.08^{ab} |

1) Values with different superscripts in the same column are significantly different at p < 0.05.

Quality of Cooked Noodle

The result of testing the quality of the cooked noodle is shown in Table 8. Water absorption of the cooked noodle was the lowest in sample 1-1. Volume of the cooked noodle was large in sample 2-2. Cooking loss was large in sample 2-2 and small in samples 1-2 and 1-3. From this result, it was confirmed that, although water absorption by the noodle during cooking increases when only the isolated soy protein-S is added, cooking loss can be reduced by adding the enzyme.

TABLE 8

| Sample | Water absorption (%) | Volume (mL) | Cooking loss (g) |
|---|---|---|---|
| 1-1 | 55.17 ± 2.98^{b} | 13.67 ± 0.29^{b} | 0.53 ± 0.08^{abcd} |
| 1-2 | 62.93 ± 2.77^{a} | 13.83 ± 0.29^{b} | 0.43 ± 0.02^{d} |
| 1-3 | 60.69 ± 0.96^{a} | 14.50 ± 0.87^{ab} | 0.40 ± 0.03^{d} |
| 2-1 | 63.40 ± 1.16^{a} | 14.67 ± 0.29^{ab} | 0.66 ± 0.02^{a} |
| 2-2 | 64.83 ± 2.74^{a} | 15.17 ± 0.76^{a} | 0.64 ± 0.17^{a} |
| 2-3 | 63.14 ± 3.45^{a} | 14.67 ± 0.29^{ab} | 0.57 ± 0.04^{ab} |
| 3-1 | 60.23 ± 2.63^{a} | 14.50 ± 0.87^{ab} | 0.60 ± 0.03^{ab} |
| 3-2 | 63.38 ± 3.48^{a} | 13.50 ± 0.00^{b} | 0.49 ± 0.03^{bcd} |
| 3-3 | 62.28 ± 2.62^{a} | 14.33 ± 1.04^{ab} | 0.47 ± 0.03^{cd} |

1) Values with different superscripts in the same column are significantly different at p < 0.05.

The result of measuring the mechanical texture of the cooked noodle is shown in Table 9. Hardness was significantly high in sample 1-3 and low in sample 1-1. To compare groups 2 and 3 wherein the isolated soy protein-S was added, the group with only the alginic acid derivative added showed higher hardness, suggesting that the addition of isolated soy protein-S provides softness. Adhesiveness was significantly high in sample 3-3 and the highest in sample 2-1, suggesting that the addition of the enzyme to the sample with the isolated soy protein-S added may result in improved adhesiveness of the cooked noodle to teeth when eating the noodle.

Springiness was significantly high in sample 3-3. When comparing the samples of group 2, springiness was higher as the content of the alginic acid derivative increased. But, the group with the enzyme added showed higher springiness. Cohesiveness was similar without regard to the addition of the isolated soy protein-S, but was significantly high in sample 3-3 in the group with the enzyme added. Gumminess and chewiness were significantly higher in group 1 wherein only the alginic acid derivative was added without the isolated soy protein-S than in group 2. They were higher as the content of the alginic acid derivative increased. When comparing groups 2 and 3, the addition of the enzyme resulted in higher values. Tensile property was higher as the content of the alginic acid derivative increased. When comparing groups 2 and 3, the addition of the enzyme resulted in improved tensile property, suggesting that the enzyme is an important additive in preparation of wet rice noodle.

Although the soy protein-S had a negative effect on consumers' preference for wet rice noodle as compared to one without containing it because of its inherent color, wet wheat noodle has the same problem since wheat flour also has inherent color. In order to utilize the characteristic of rice noodle, protein with no color may be used or rice may be decolored to give white color. Whey protein, soybean protein, rice protein or corn protein with high glutamine content may be used in this regard.

The effect of the addition of protein, which is insufficient in rice, and enzyme on the improvement of noodle quality was confirmed as described above.

TABLE 9

| Sample | Hardness | Adhesiveness | Springiness | Cohesiveness |
|---|---|---|---|---|
| 1-1 | 1603.84 ± 99.67^{d} | −17.71 ± 3.19^{cd} | 0.64 ± 0.06^{d} | 0.45 ± 0.02^{d} |
| 1-2 | 22.59 ± 277.20^{b} | −17.27 ± 9.07^{c} | 0.66 ± 0.07^{cd} | 0.46 ± 0.03^{cd} |
| 1-3 | 2540.25 ± 149.52^{a} | −9.89 ± 2.67^{ab} | 0.72 ± 0.03^{ab} | 0.52 ± 0.01^{b} |
| 2-1 | 1766.75 ± 64.27^{cd} | −23.88 ± 4.73^{d} | 0.66 ± 0.04^{cd} | 0.44 ± 0.02^{d} |
| 2-2 | 2324.08 ± 173.62^{b} | −13.01 ± 6.65^{bc} | 0.70 ± 0.03^{bc} | 0.52 ± 0.01^{b} |
| 2-3 | 2282.26 ± 258.2^{b} | −15.20 ± 9.26^{bc} | 0.70 ± 0.03^{abc} | 0.52 ± 0.01^{b} |
| 3-1 | 1703.54 ± 65.03^{cd} | −17.74 ± 3.43^{cd} | 0.62 ± 0.04^{d} | 0.450 ± 0.01^{d} |
| 3-2 | 1856.42 ± 89.81^{d} | −12.39 ± 3.40^{bc} | 0.69 ± 0.05^{bc} | 0.48 ± 0.01^{b} |
| 3-3 | 2199.43 ± 194.73^{b} | −5.55 ± 1.22^{a} | 0.76 ± 0.02^{a} | 0.57 ± 0.01^{a} |
| | | | | Elastic Limit |
| Sample | Gumminess | Chewiness | Resilience | (Tensile Strength) |
| 1-1 | 715.73 ± 59.87^{a} | 458.98 ± 69.78^{d} | 0.19 ± 0.02^{cd} | 24.97 ± 3.68^{b} |
| 1-2 | 1041.931 ± 29.57^{c} | 697.32 ± 119.69^{c} | 0.20 ± 0.01^{a} | 32.78 ± 4.34^{b} |
| 1-3 | 1332.07 ± 97.36^{a} | 953.55 ± 82.88^{a} | 0.26 ± 0.01^{b} | 51.52 ± 10.42^{a} |
| 2-1 | 785.36 ± 27.59^{a} | 517.06 ± 43.56^{d} | 0.18 ± 0.01^{f} | 32.10 ± 8.29^{b} |
| 2-2 | 1216.28 ± 94.30^{b} | 853.64 ± 98.70^{b} | 0.24 ± 0.01^{c} | 48.79 ± 10.72^{a} |
| 2-3 | 1177.301 ± 33.82^{b} | 831.86 ± 99.78^{d} | 0.25 ± 0.01^{bc} | 49.55 ± 8.46^{a} |
| 3-1 | 765.35 ± 37.78^{a} | 473.68 ± 33.4^{d} | 0.19 ± 0.01 ^{d} | 33.66 ± 6.54^{b} |
| 3-2 | 885.19 ± 32.80^{d} | 612.49 ± 61.04^{c} | 0.22 ± 0.02^{d} | 46.16 ± 5.12^{a} |
| 3-3 | 1251.371 ± 17.21^{ab} | 948.53 ± 107.55^{a} | 0.29 ± 0.01^{a} | 56.15 ± 8.12^{a} |

1) Values with different superscripts in the same column are significantly different at p < 0.05.

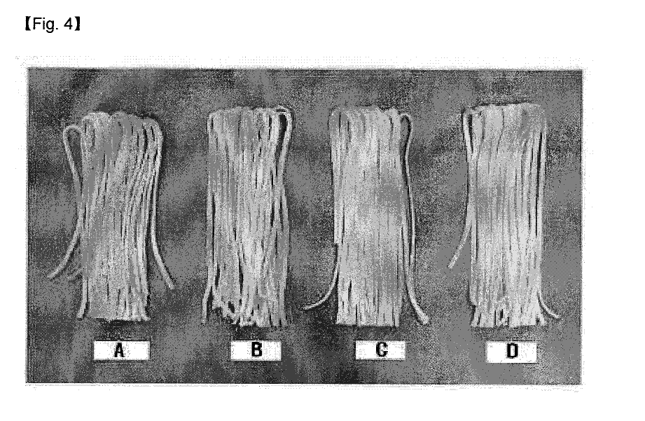

FIG. 3 shows the cooked noodle of each sample. It can be seen that the thickness of the cooked noodle increases and noodle breaking is reduced as the addition amount of the alginic acid derivative increases. Group 1 with no isolated soy protein-S added exhibited very white color.

The sensation test result of the rice noodle is shown in Table 10. Group 1 showed high, but not significant, gloss. Group 1 with no isolated soy protein-S added showed significant difference in color. The sample exhibiting white color tended to show high gloss. Group 1 with no isolated soy protein-S added showed high hardness. The addition of the isolated soy protein-S resulted in decreased hardness and the addition of the enzyme resulted in softness, which was in agreement with the mechanical measurement. Gumminess and chewiness were higher as the addition amount of the alginic acid derivative increased, although not significant. Overall quality was better in group 1 with no isolated soy protein-S added showed than groups 2 or 3, but there was no significant difference. The reason why group 1 showed good overall quality might be because the panels prefer white noodle.

TABLE 10

| | | | | | | | | Cooking | Overall |
|---|---|---|---|---|---|---|---|---|---|
| Sample | Gloss | Color | Flavor | Hardness | Chewiness | Elasticity | Adhisiveness | degree | quality |
| 1-1 | 6.23 ± 1.42 | 7.15 ± 0.80^{a} | 6.23 ± 1.30 | 7.54 ± 0.97^{a} | 7.15 ± 0.08^{a} | 6.23 ± 1.48 | 4.69 ± 2.18 | 6.08 ± 1.50 | 6.46 ± 1.33 |
| 1-2 | 6.77 ± 1.09 | 7.54 ± 0.88^{a} | 6.00 ± 1.47 | 6.92 ± 0.76^{abc} | 7.08 ± 0.95^{a} | 6.77 ± 1.09 | 3.77 ± 1.59 | 6.08 ± 1.26 | 6.00 ± 1.08 |
| 1-3 | 5.85 ± 1.91 | 7.08 ± 1.19^{a} | 5.00 ± 1.58 | 7.00 ± 1.15^{ab} | 6.31 ± 1.75^{ab} | 6.54 ± 1.61 | 3.85 ± 1.46 | 5.62 ± 1.61 | 6.08 ± 1.93 |
| 2-1 | 6.54 ± 1.33 | 5.08 ± 1.50^{b} | 5.77 ± 1.30 | 6.15 ± 0.99^{bc} | 6.23 ± 1.09^{ab} | 6.23 ± 1.36 | 3.92 ± 1.26 | 6.15 ± 0.99 | 6.23 ± 0.93 |
| 2-2 | 5.85 ± 1.86 | 5.31 ± 1.75^{b} | 5.54 ± 1.51 | 6.15 ± 1.14^{bc} | 6.46 ± 1.27^{ab} | 5.46 ± 1.90 | 4.38 ± 1.85 | 5.69 ± 1.44 | 5.31 ± 1.55 |
| 2-3 | 6.85 ± 1.68 | 4.77 ± 2.01^{b} | 6.00 ± 1.08 | 6.69 ± 1.03^{abc} | 6.77 ± 1.36^{a} | 6.321 ± 1.97 | 3.69 ± 1.75 | 5.54 ± 1.61 | 5.31 ± 1.49 |
| 3-1 | 5.69 ± 1.49 | 5.62 ± 1.56^{b} | 5.85 ± 1.57 | 5.92 ± 1.32^{c} | 5.62 ± 1.31^{b} | 5.46 ± 1.66 | 3.92 ± 1.71 | 5.85 ± 1.46 | 5.46 ± 1.51 |
| 3-2 | 5.54 ± 1.76 | 5.54 ± 1.51^{b} | 6.38 ± 0.96 | 5.92 ± 1.26^{c} | 6.08 ± 0.95^{ab} | 5.46 ± 1.81 | 3.69 ± 1.80 | 5.85 ± 1.28 | 5.92 ± 1.89 |
| 3-3 | 5.92 ± 1.44 | 5.15 ± 1.57^{b} | 6.62 ± 0.87 | 6.38 ± 1.39^{bc} | 6.31 ± 0.85^{ab} | 6.31 ± 1.89 | 4.08 ± 2.18 | 6.00 ± 1.29 | 5.62 ± 1.56 |

1) Values with different superscripts in the same column are significantly different at p < 0.05.

Test 3

In order to investigate whether use of a combination of gums has a synergic effect on the quality of noodle, wet rice noodle was prepared using alginic acid derivative and xanthan gum as described in Table 3.

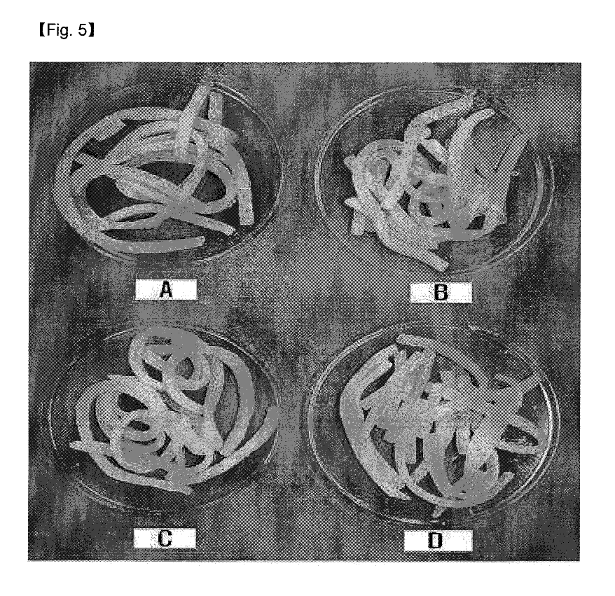

The prepared wet rice noodle is shown in FIG. 4. All the 4 samples could be prepared into noodle and sample C was brighter and whiter than other wet noodle samples. The difference in additives may have caused the result.

Quality of Cooked Noodle

The quality of the cooked noodle is shown in Table 11. In terms of noodle quality, the alginic acid derivative is thought to be more effective. Volume of the cooked noodle was the largest for sample B, followed by A, C and D.

TABLE 11

| Sample | Weight increase (%) | Water Content (%) | Volume (mL) |
|---|---|---|---|
| A | 138.52 ± 3.13^{ab} | 38.52 ± 3.13^{ab} | 12.5 ± 0.71 |
| B | 124.95 ± 4.05^{c} | 26.95 ± 4.05^{c} | 14.0 ± 2.12 |
| C | 145.58 ± 1.91^{a} | 45.58 ± 1.91^{a} | 12.5 ± 3.54 |
| D | 131.22 ± 0.75^{bc} | 31.22 ± 0.74^{bc} | 11.0 ± 0.00 |

1) Values with different superscripts in the same column are significantly different at p < 0.05.

The shape of the cooked noodle is shown in FIG. 5. The noodle of samples B and D lacked springiness and was broken, whereas that of samples A and C showed springiness and gloss, with less breaking. It was found out that the addition of alginic acid derivative results in stabilized network structure and thus reduces cooking loss during the cooking of noodle. It was also found out that the cooking loss can be further reduced when xanthan gum and alginic acid derivative were added together than when only the alginic acid derivative was added. However, since customers' preference is also an important factor, the proportion of the gums can be controlled appropriately.

The sensation test for the rice noodle is shown in Table 12. Gloss was the highest in sample D and significantly low in sample B in which xanthan was added. Hardness was high in samples A and C. Chewiness was significantly high in sample C. The wet rice noodle with alginic acid derivative added showed better chewiness, hardness and springiness than that containing other additive. In preference, sample C showed the best, significantly high overall quality. It is thought that the addition of alginic acid derivative affects the texture of noodle and improves the quality of noodle, as shown from the cooking test.

To conclude, it was confirmed that wet rice noodle could be prepared only with rice flour without addition of wheat flour. It was also confirmed that gluten-free wet rice noodle, which was neither extruded nor steamed, could be prepared from rice flour instead of wheat flour. Consistent study on various additives will be necessary for further improvement of the structure and cooking quality of the wet rice noodle.

TABLE 12

| | | | | | | | | | Overall |
|---|---|---|---|---|---|---|---|---|---|
| Sample | Gloss | Color | Flavor | Hardness | Chewiness | Elasticity | Adhisiveness | Cooked | quality |
| A | 5.60 ± 0.52^{a} | 5.20 ± 1.48 | 5.30 ± 1.49 | 6.00 ± 1.82^{a} | 5.00 ± 1.70^{ab} | 5.20 ± 1.62 | 4.60 ± 1.90 | 5.70 ± 1.16 | 5.70 ± 1.42^{a} |
| B | 4.10 ± 1.45^{b} | 5.10 ± 1.29 | 5.20 ± 1.55 | 4.20 ± 1.03^{b} | 4.00 ± .067^{b} | 4.20 ± 0.79 | 5.00 ± 1.25 | 5.00 ± 1.25 | 4.30 ± 0.67^{b} |
| C | 5.60 ± 1.58^{a} | 5.30 ± 1.42 | 5.10 ± 1.37 | 6.00 ± .094^{a} | 5.50 ± 085^{a} | 5.30 ± 1.34 | 4.50 ± 1.96 | 5.30 ± 1.57 | 6.20 ± 0.92^{a} |
| D | 6.00 ± 0.82^{a} | 5.30 ± 1.06 | 5.80 ± 1.23 | 3.40 ± 1.71^{b} | 2.80 ± 1.40^{c} | 3.70 ± 2.21 | 4.50 ± 2.32 | 4.40 ± 2.07 | 3.10 ± 1.29^{c} |

1) Values with different superscripts in the same column are significantly different at p < 0.05.

Test 4

In order to investigate the effect of rice species on the quality of noodle, Shinsunchalbyeo (glutinous rice), Goami (high-amylose rice), That rice and Hopyeongbyeo (nonglutinous rice) were used as described in Table 13.

TABLE 13

| | Rice | Soybean | Gum | Enzyme | Water | Salt |
|---|---|---|---|---|---|---|
| Rice species | flour (g) | protein (g) | (g) | (g) | (mL) | (g) |
| Shinsunchalbyeo | 80 | 2 | 0.4 | 0.1 | 67 | 2 |
| Goami | 80 | 2 | 0.4 | 0.1 | 67 | 2 |
| Thai rice | 80 | 2 | 0.4 | 0.1 | 67 | 2 |
| Hopyeongbyeo | 80 | 2 | 0.4 | 0.1 | 67 | 2 |

With the flour of the glutinous rice Shinsunchalbyeo, rice noodle could not be formed.

Color of Wet Rice Noodle

Noodle could be prepared from other rice flour. The result of color analysis for the prepared wet noodle is shown in Table 14. Lightness (L) was significantly, the highest for Goami (89.68) and the lowest for Hopyeongbyeo (87.53). Redness (a) was high for Goami (−0.31) and That rice (−0.32). Yellowness (b) was the highest for That rice (8.46) and the lowest for Goami (6.75), with significant difference.

TABLE 14

| Rice species | L | a | b |
|---|---|---|---|
| Goami | 89.68 ± 0.18^{a} | −0.31 ± 0.03^{a} | 6.75 ± 0.13^{c} |
| Thai rice | 88.16 ± 0.27^{b} | −0.32 ± 0.02^{a} | 8.46 ± 0.17^{a} |
| Hopyeongbyeo | 87.83 ± 0.09^{c} | −0.40 ± 0.02^{b} | 7.16 ± 0.06^{b} |

1) Values with different superscripts in the same column are significantly different at p < 0.05.

Quality of Cooked Noodle

The quality of the cooked noodle is shown in Table 15. Water absorption of the cooked noodle was highest for That rice (61.88%) and lowest for Goami (34.11%). Volume of the cooked noodle was highest for That rice (13.83 mL) and cooking loss was lower for That rice (0.69%) than for Hopyeongbyeo (0.77%). Goami showed the highest, significant cooking loss (1.12%). This is in agreement with the result of the cooking test of wet noodle where Goami noodle showed loosening during cooking.

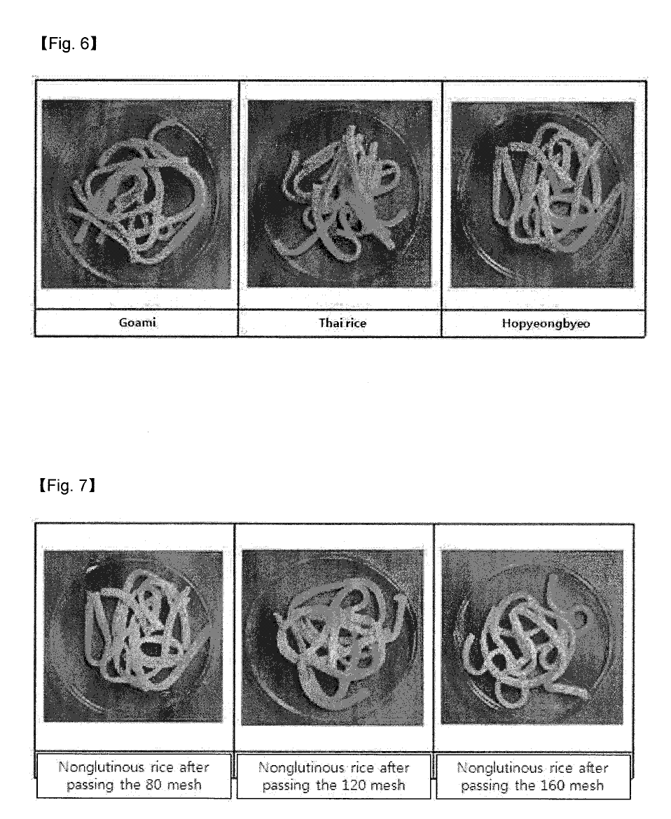

The shape of the cooked noodle is shown in FIG. 6. The Goami noodle was long without breaking. The That rice noodle was sticky and broken. The Hopyeongbyeo noodle was well-shaped and glossy as compared to other noodle.

The result of measuring the mechanical texture of the cooked noodle is shown in Table 16. Hardness was highest for Goami (1577.19) and lowest for That rice. The cooked noodle prepared from That rice was sticky and thinner as compared to other rice species. Adhesiveness was the highest for Goami (−6.48). Springiness was significantly high for That rice and Hopyeongbyeo and low for Goami. This is because the Goami rice is hard but less springy. Cohesiveness was low for Goami. Gumminess and chewiness were significantly high for Hopyeongbyeo and lowest for Goami. Although the cooked noodle of Goami was hard, viscosity, springiness and chewiness were not good. Hopyeongbyeo noodle was not so hard as Goami noodle, but gumminess, chewiness and springiness were better. Thus, it seems that better noodle quality can be obtained when Hopyeongbyeo is used.

TABLE 16

| | | | | | | | | Elastic |
|---|---|---|---|---|---|---|---|---|
| | | | | | | | | Limit/ |
| | | Adhesive- | | Cohesive- | | | | Tensile |
| Rice species | Hardness | ness | Springiness | ness | Gumminess | Chewiness | Resilience | Strength |
| Goami | 1562.65 ± 60.92^{a} | −6.25 ± 1.09^{a} | 0.60 ± 0.04^{b} | 0.35 ± 0.01^{b} | 539.45 ± 19.71^{c} | 319.36 ± 22.35^{c} | 0.15 ± 0.01^{b} | 32.05 ± 2.42 |
| Thai rice | 1325.65 ± 80.60^{c} | −25.22 ± 6.69^{b} | 0.744 ± 0.04^{a} | 0.49 ± 0.02^{a} | 652.45 ± 53.22^{b} | 486.41 ± 61.20^{b} | 0.19 ± 0.01^{a} | 30.01 ± 2.45 |
| Hopyeongbyeo | 1458.77 ± 72.92^{b} | −28.95 ± 7.24^{b} | 0.73 ± 0.02^{a} | 0.49 ± 0.01^{a} | 715.27 ± 32.77^{a} | 525.58 ± 29.14^{a} | 0.19 ± 0.01^{a} | 35.24 ± 4.73 |

1) Values with different superscripts in the same column are significantly different at p < 0.05.

Test 5

With Hopyeongbyeo, the effect of the particle size (80, 120 and 160 mesh) of rice flour on noodle quality was investigated as described in Table 17.

TABLE 17

| Particle size | Rice | Soybean | Gum | Enzyme | Water | Salt |
|---|---|---|---|---|---|---|
| (mesh) | flour (g) | protein (g) | (g) | (g) | (mL) | (g) |
| 80 | 80 | 2 | 0.4 | 0.1 | 67 | 2 |
| 120 | 80 | 2 | 0.4 | 0.1 | 67 | 2 |
| 160 | 80 | 2 | 0.4 | 0.1 | 67 | 2 |

The result of measuring the color of wet noodle is shown in Table 18. Lightness (L) was highest for 120 mesh (88.24) and lowest for 160 mesh (86.95). Redness (a) was highest for 80 mesh (−0.40) and lowest for 160 mesh (−0.52). Yellowness (b) was highest for 160 mesh (8.15), followed by 120 and 80 mesh.

TABLE 18

| Particle size | | | |
|---|---|---|---|
| (mesh) | L | a | b |
| 80 | 87.83 ± 0.09^{b} | −0.40 ± 0.02^{a} | 7.16 ± 0.06^{c} |
| 120 | 88.24 ± 0.21^{a} | −0.43 ± 0.02^{b} | 7.93 ± 0.09^{b} |
| 160 | 86.95 ± 0.15^{c} | −0.52 ± 0.01^{c} | 8.15 ± 0.05^{a} |

1) Values with different superscripts in the same column are significantly different at p < 0.05.

Test result for the cooked noodle is shown in Table 19. Although no significant difference was observed depending on the particle size, 120-mesh Hopyeongbyeo showed high water absorption and volume as compared with other particle size and showed the lowest cooking loss.

TABLE 19

| Particle size | Water absorption of | Volume of cooked | Cooking loss |
|---|---|---|---|
| (mesh) | cooked noodle (%) | noodle (mL) | (g) |
| 80 | 53.20 ± 4.83 | 13.67 ± 0.29 | 0.77 ± 0.05 |
| 120 | 57.70 ± 4.85 | 14.17 ± 0.76 | 0.74 ± 0.01 |
| 160 | 54.15 ± 3.04 | 13.67 ± 0.290 | 0.83 ± 0.03 |

1) Values with different superscripts in the same column are significantly different at p < 0.05.

The shape of the cooked noodle is shown in FIG. 7. The cooked noodle has smooth appearance without breaking.

The result of measuring the mechanical texture of the cooked noodle is shown in Table 20. Hardness was highest for 80-mesh rice flour (1458.77) and lowest for 120-mesh rice flour. Adhesiveness was lowest for 80-mesh rice flour (−28.95) and high for 120- and 160-mesh rice flour. Springiness was significantly for 160-mesh rice flour and lowest for 120-mesh rice flour. It can be seen that the particle size does not have a significant effect on the quality of rice noodle within the range of 80-160 mesh.

It was confirmed that rice species, method for preparing rice flour, particle size of rice flour (80-120 mesh) and addition amount of gum (alginic acid derivative), protein, protein-crosslinking enzyme (transglutaminase) and water are important factors in the preparation of rice noodle.

TABLE 20

| | | | | | | | | Elastic |
|---|---|---|---|---|---|---|---|---|
| Particle | | | | | | | | Limit/ |
| size | | | | | | | | Tensile |
| (mesh) | Hardness | Adhesiveness | Springiness | Cohesiveness | Gumminess | Chewiness | Resilience | Strength |
| 80 | 1458.77 ± 72.92^{a} | −28.95 ± 7.24^{b} | 0.73 ± 0.02^{b} | 0.49 ± 0.01^{b} | 715.27 ± 32.77^{a} | 525.58 ± 29.14^{a} | 0.19 ± 0.01^{b} | 35.24 ± 4.73 |
| 120 | 1178.76 ± 62.70^{c} | −14.07 ± 9.53^{a} | 0.71 ± 0.04^{c} | 0.47 ± 0.02^{b} | 560.17 ± 47.88^{c} | 397.89 ± 52.45^{b} | 0.20 ± 0.01^{b} | 29.31 ± 3.71 |
| 160 | 1263.14 ± 50.12^{b} | −11.77 ± 6.31^{a} | 0.77 ± 0.02^{a} | 0.52 ± 0.01^{a} | 660.71 ± 35.17^{b} | 510.54 ± 30.86^{a} | 0.24 ± 0.02^{a} | 29.86 ± 3.06 |

1) Values with different superscripts in the same column are significantly different at p < 0.05.

### Example 2

### Preparation of Gluten-Free Rice Cup Cake (Baking Cup Diameter 10 cm, for 18 Pieces)

Egg (250 g), sugar (80 g, Baeksul) and salt (2 g) were melted at 40-45° C. (by heating in a water bath) and mixed at high speed in a mixer so that air bubbles were formed. Then, the mixing speed was decreased so that the air bubbles became smaller and uniform.

Nonglutinous rice flour (130 g) was added to the mixture. After mixing well, cheongju (30 g) and cooking oil (30 g, Haepyo) were partly added to the mixture to form batter. Then, the remaining cheongju and cooking oil were added and dough was prepared.

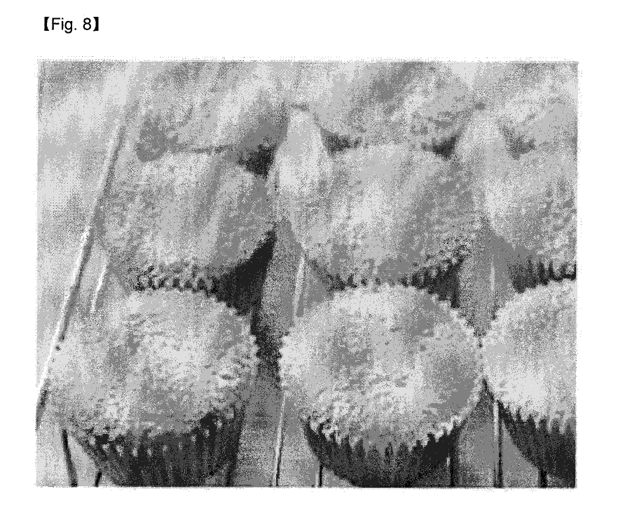

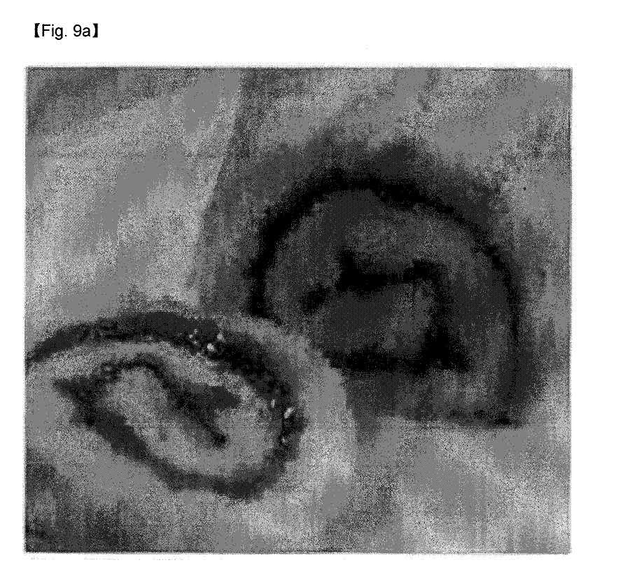

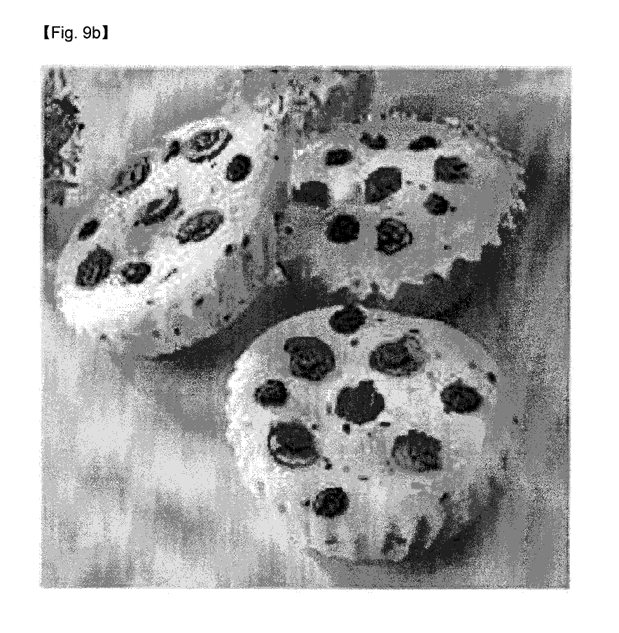

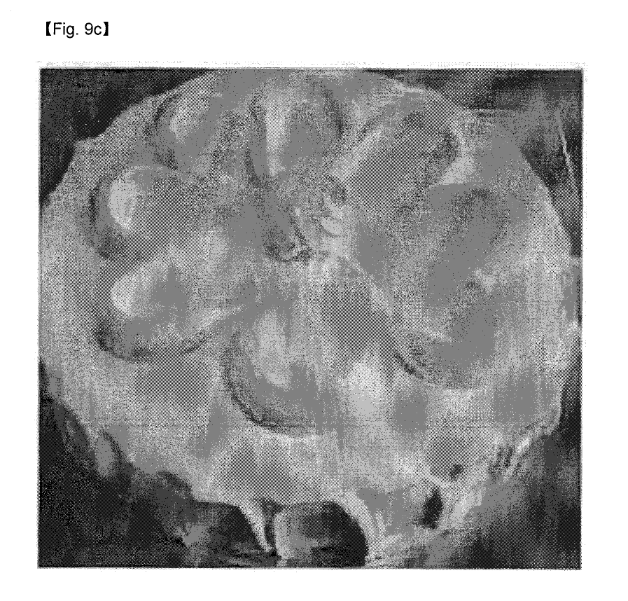

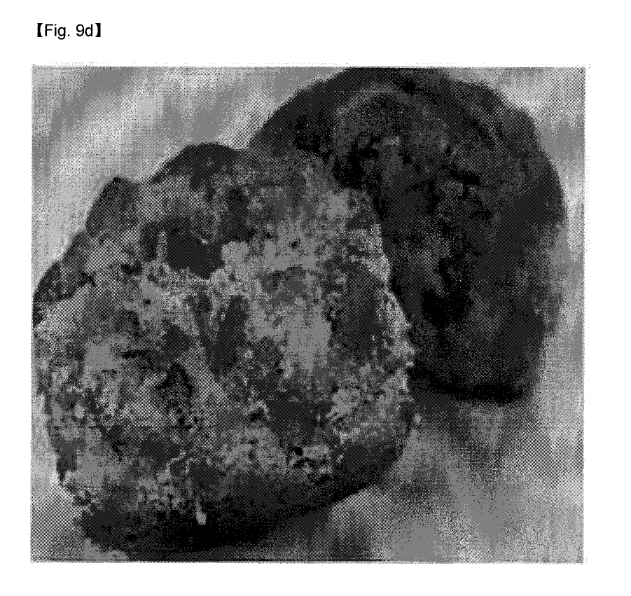

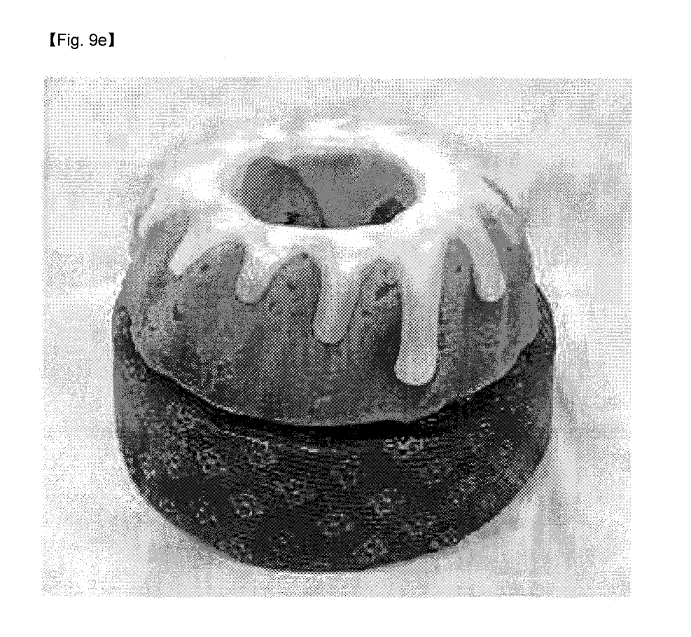

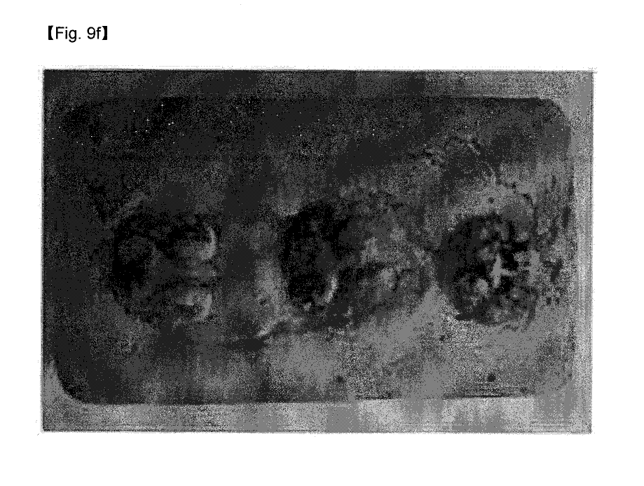

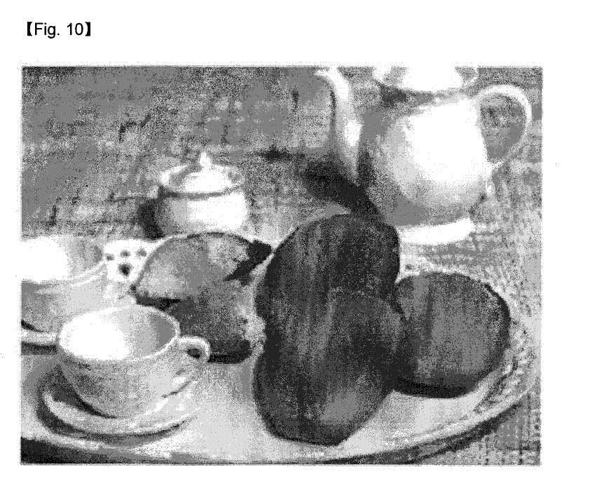

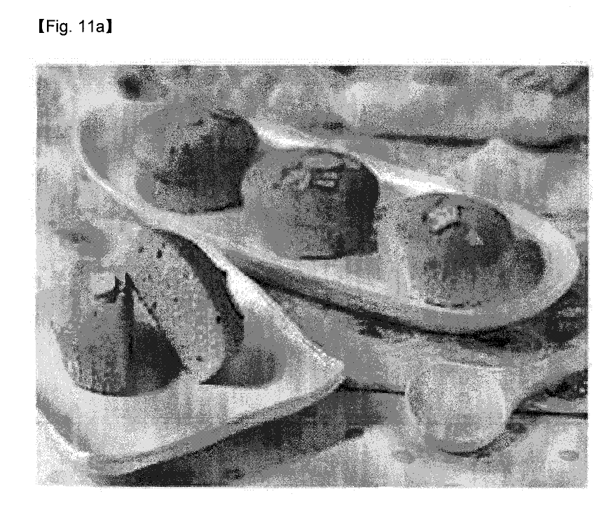

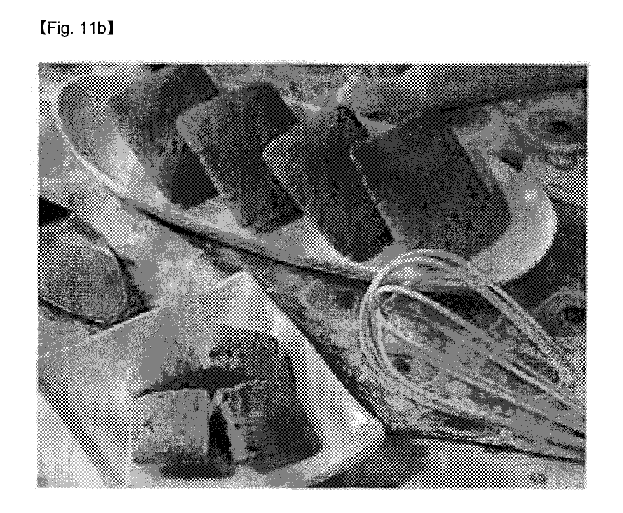

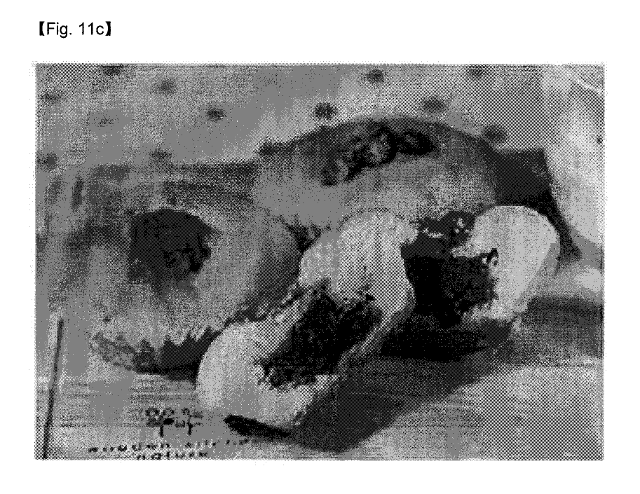

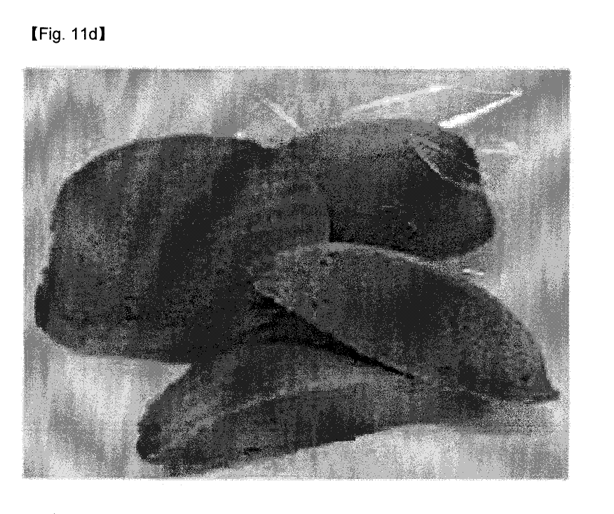

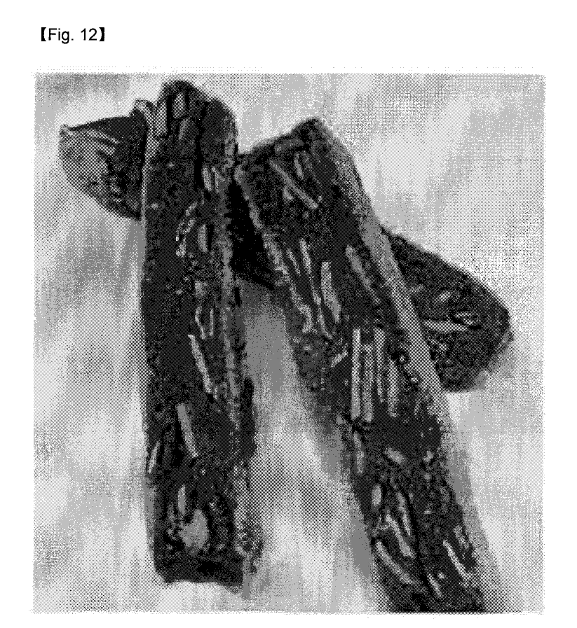

The dough was filled in a baking cup (diameter 10 cm) up to about 80% using a pastry bag and baked in a preheated oven (upper portion 180° C., lower portion 150° C.) for 15-20 minutes to prepare rice cake (FIG. 8).

The resulting cake was cooled at room temperature for about 4 hours and subjected to sensation test. Also, wheat cake was prepared as described in Table 21 for comparison with the rice cake.

TABLE 21

| | | Comparative Example 1 |
|---|---|---|
| Ingredients | Content (g) | (wheat cake) |
| Nonglutinous rice flour | 130 | 0 |
| Weak flour | 0 | 130 |
| Butter | 0 | 30 |
| Egg | 250 | 160 |
| Sugar | 80 | 120 |
| Starch syrup | 0 | 30 |
| Cooking oil | 30 | 0 |
| Cheongju | 30 | 0 |
| Salt | 2 | 2 |
| Total | 522 | 472 |

### Comparative Example 5

### Sensation Test for Gluten-Free Rice Cup Cake and Wheat Cake

Sensation test was carried out for the rice cup cake prepared from the rice cake composition of Example 2 and the wheat cake of Comparative Example 1 and Comparative Example 2 (wheat cake commercially available from Korea's C company). Randomly selected ten panels evaluated physicochemical characteristics including smell, texture, flavor and volume. The rice flour cake prepared in Example 1 was superior to those of Comparative Examples 1 and 2 in smell, texture and taste. There was no significant difference in (specific) volume (Table 22).

TABLE 22

| | Sensation test items | | | |
|---|---|---|---|---|
| | | Texture | Taste | Specific |
| | Smell | (uniformity) | (flavor) | volume (cc/g) |
| Example 1 | 4.5 | 4.3 | 4.0 | 3.8 |
| Comparative Example 1 | 4.2 | 4.0 | 3.9 | 3.7 |
| Comparative Example 2 | 3.3 | 3.4 | 3.5 | 3.8 |
| (wheat cake, C company) | | | | |

5-point scale: 1=very poor, 2=poor, 3=moderate, 4=good, 5=very good.

### Example 3

### Preparation of Various Gluten-Free Rice Cake

Rice cake was prepared from the rice cake composition of Example 2.

As in Example 2, egg, sugar and salt were melted by heating in a water bath, mixed at high speed in a mixer and lightly mixed with sieved rice flour. Then, after adding cheongju and cooking oil, the resulting dough was filled in a baking cup up to about 80% using a pastry bag.

Roll cake was prepared by the foaming method. Egg white and yolk were separated. The yolk was foamed after adding sugar, starch syrup and salt, and the white was prepared into 80% meringue by adding sugar. The yolk mixture and the white meringue were mixed in half and lightly mixed with sieved rice flour. After adding the remaining meringue as well as cheongju and cooking oil, the resulting dough was baked on a pan for about 25 minutes and then rolled after applying jam or cream.

Chiffon cake was prepared as follows. Egg white and yolk were separated from each other. The yolk was stirred at low speed after adding water and sugar. The white was prepared into 80% meringue by adding sugar. The yolk mixture and the white meringue were lightly mixed after being divided into 3 portions and then mixed with rice flour. After spraying water, the resulting dough was baked on a chiffon pan for about 25 minutes.

Sweet potato rice castella was prepared as follows. Butter was softly melted and mixed at high speed after adding sugar. Then, after adding yolk, the mixture was prepared into cream. Egg white was prepared into 90% meringue and mixed with the creamed yolk mixture in half and then with sieved rice flour mixture. After adding cooking oil and dried walnut and lightly mixing with the remaining meringue, parboiled sweet potato was picked intermittently in the dough. After putting topping, the dough was baked for about 20 minutes.

Steamed cake was prepared as follows. Egg, salt and sugar were heated in a water bath and mixed at high speed so that air bubbles were formed. Then, after mixing with sieved rice flour and adding water and cheongju, the remaining nut was mixed. The resulting dough was filled in a cup up to about 80% using a pastry bag and steamed in a steamer for 12 minutes.

Rice sponge cake was prepared as follows. Egg, sugar, starch syrup and salt were mixed and heated in a water bath so that air bubbles were formed. Then, after mixing with rice flour, butter heated in a water bath was added. The resulting dough was panned to specific gravity 0.5-0.6 and, after cooling, baked for about 25 minutes.

Rice castella was prepared as follows. After adding sugar, salt and starch syrup to egg and mixing at high speed while heating in a water bath (50° C.), the mixture was lightly mixed with rice flour. The resulting dough was mixed with water and cooking oil, filled in a cake mold up to about 70% after placing paper, and baked in an oven for about 25 minutes.

White rice cake was prepared as follows. Egg, sugar, starch syrup and salt were mixed and heated in a water bath so that air bubbles were formed. Then, after mixing with rice flour and lightly mixing with butter heated in a water bath, the resulting dough was baked in an oven for about 20 minutes. The resulting cake was decorated with dairy cream or butter cream icing.

Polished rice muffin was prepared as follows. After lightly melting butter, sugar was added to prepare cream by adding egg was. After lightly mixing with sieved rice flour, milk and cheongju were added to adjust the water content and degree of kneading of the dough. After adding walnut and dried strawberry, the resulting dough was filled in a baking cup up to about 80% using a pastry bag and then baked on a preheated oven for about 20 minutes.

Polished rice gugelhopf was prepared as follows. Egg yolk and white were separated. After adding sugar and salt to butter and whipping, the yolk was added to prepare cream. Sieved almond flour was lightly mixed with the yolk mixture. The egg white was prepared into 80% meringue by adding sugar in small portions. The creamed yolk mixture was mixed with the white meringue in half. After mixing with sieved rice flour and milk, followed by light mixing with the remaining meringue, pretreated fig was added and dough was prepared. The dough was filled in a gugelhopf mold up to about 75% and baked in an oven for about 40 minutes.

Polished rice pound cake was prepared as follows. Butter was softened by mixing with shortening. After adding sugar and salt and mixing, followed by addition of egg in small amount, the mixture was prepared into cream. Then, after lightly mixing with sieved rice flour, the resulting dough was panned on a pound pan and baked in an oven for about 40 minutes.

Rice cheesecake was prepared as follows. Rice flour was mixed with milk ensuring that lump was not formed. In another bowl, dairy cream and milk were boiled while adding shredded cheese. After mixing the two mixtures and boiling again, followed by mixing with citron juice and egg yolk, the mixture was cooled. Egg white was prepared into ˜80% meringue by adding sugar. After lightly mixing, the resulting dough was panned and heated in a water bath for 60-100 minutes.

### Example 4

### Preparation of Polished Rice Citron Madeleine (25 Pieces, Per Pan)

Nonglutinous rice flour (200 g) was mixed with egg (200 g), sugar (100 g), honey (20 g) and baking powder (4 g) in a bowl. After preparing dough by stirring ensuring that lump was not formed, smashed citron jam (20 g) and cheongju (50 g) were mixed with the dough. After slowly adding butter (140 g) heated in a water bath at 40-45° C. to the dough and preparing smooth dough by stirring, the dough was rested in a refrigerator at 4° C. for 30 minutes.

The dough was put in a madeleine pan to fill about 80% of the pan volume and then baked in a preheated oven (upper portion 180° C., lower portion 150° C.) for 15-20 minutes to prepare polished rice citron madeleine (FIG. 10). The baked madeleine was cooled at room temperature for about 4 hours and subjected to sensation test. Also, baked wheat confectionery was prepared as described in Table 23.

TABLE 23

| | | Comparative Example 1 |
|---|---|---|
| Ingredients | Content (g) | (baked wheat confectionery) |
| Rice flour | 200 | 0 |
| Weak flour | 0 | 200 |
| Butter | 140 | 200 |
| Egg | 200 | 200 |
| Sugar | 100 | 200 |
| Honey | 20 | 0 |
| Baking powder | 4 | 4 |
| Cheongju | 50 | 0 |
| Salt | 0 | 1 |
| Citron jam | 20 | 0 |
| Total | 734 | 805 |

### Comparative Example 6

### Sensation Test for Gluten-Free Baked Rice Confectionery and Baked Wheat Confectionery

Sensation test was carried out for the baked rice confectionery prepared from the rice madeleine composition of Example 4 and the baked wheat confectionery of Comparative Example 1. Randomly selected ten panels evaluated physicochemical characteristics including smell, texture, flavor and volume.

The baked rice confectionery prepared from the rice madeleine composition of Example 4 was significantly superior to that of Comparative Example 1 in smell, texture and taste. There was no significant difference in (specific) volume (Table 24).

TABLE 24

| | Sensation test items | | | |
|---|---|---|---|---|
| | | Texture | Taste | Specific |
| | Smell | (uniformity) | (flavor) | volume (cc/g) |
| Example 1 | 4.3 | 4.4 | 4.3 | 4.0 |
| Comparative Example 1 | 3.9 | 3.8 | 3.7 | 3.9 |

5-point scale: 1=very poor, 2=poor, 3=moderate, 4=good, 5=very good.

### Example 5

### Preparation of Various Gluten-Free Baked Rice Confectionery

Polished rice bamboo leaf madeleine, polished rice gingerbread, polished rice black tea financier, glutinous rice petit, rice dorayaki and rice stick brownie were prepared using the dough composition for preparing the polished rice citron madeleine baked confectionery prepared in Example 4.

Polished rice ginger madeleine was prepared by adding 0-30 parts by weight of ginger juice instead of the citron jam. Polished rice black tea financier was prepared by adding 30-70 parts by weight of black tea powder. Glutinous rice petit was prepared by 250 parts by weight of red bean paste. Polished rice bamboo leaf madeleine was prepared by adding 3-7 parts by weight of bamboo leaf powder. Rice dorayaki was prepared by adding uncracked red bean paste. And, rice stick brownie was prepared by adding 200-300 parts by weight of chocolate powder and cocoa powder.

### Example 6

### Preparation of Rice Choco-Stick Cookie (1×10 cm, 80 Pieces)

Rice stick choco-cookie was prepared as follows.

Butter (150 g) was softly ground in a mixer and, after adding sugar (100 g), prepared into cream by whipping. Then, after mixing with egg (120 g), dough was prepared by lightly mixing with sieved rice flour (400 g), almond flour (30 g) and cocoa powder (24 g).

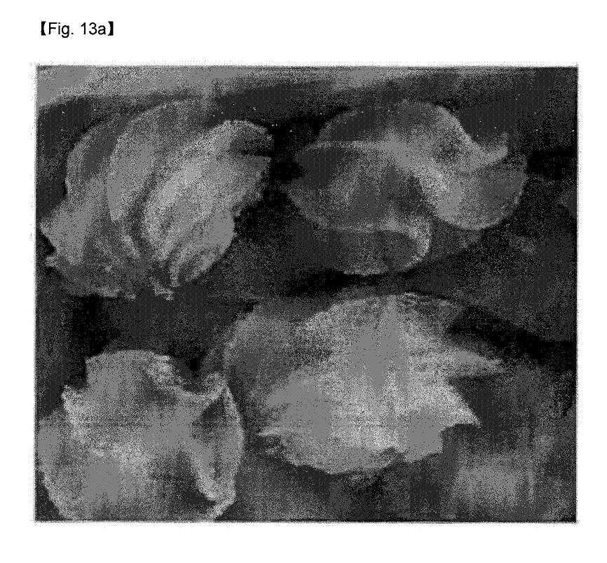

The degree of kneading of the dough was controlled while adding milk (50 g). After adding dairy cream (20 g), the dough was uniformly spread, sliced to 1 cm thickness and kept in a freezer. After applying egg white and sugar on the frozen dough in the freezer, the dough was cut to a size of 1 cm×10 cm, panned and baked in a preheated oven (upper portion 190° C., lower portion 165° C.) for 15 minutes to prepare rice choco-stick cookie (FIG. 12). The baked cookie was cooled at room temperature for about 4 hours and subjected to sensation test. Also, wheat cookie was prepared as described in Table 25.

TABLE 25

| | | Comparative Example 1 |
|---|---|---|
| Ingredients | Content (g) | (wheat cookie) |
| Rice flour | 400 | 0 |
| Weak flour | 0 | 400 |
| Butter | 150 | 280 |
| Egg | 120 | 120 |
| Sugar | 100 | 200 |
| Milk | 60 | 0 |
| Almond flour | 30 | 0 |
| Cocoa powder | 20 | 20 |
| Vanilla powder | 0 | 2 |
| Salt | 0 | 4 |
| Dairy cream | 20 | 0 |
| Total | 900 | 1026 |

### Comparative Example 7

### Sensation Test for Gluten-Free Rice Cookie and Wheat Cookie

Sensation test was carried out for the rice cookie prepared from the composition for preparing rice cookie of Example 6 and the wheat cookie of Comparative Example 1. Randomly selected ten panels evaluated physicochemical characteristics including smell, texture, flavor and volume.

The rice cookie prepared from the composition for preparing rice cookie of Example 6 was significantly superior to that of Comparative Example 1 in smell, texture and taste. There was no significant difference in (specific) volume (Table 26).

TABLE 26

| | Sensation test items | | | |
|---|---|---|---|---|
| | | | | Appearance |
| | | Texture | Taste (sweetness, | (shape, color, |
| | Smell | (uniformity) | richness) | size) |
| Example 1 | 4.8 | 4.6 | 4.7 | 4.8 |
| Comparative | 4.4 | 4.1 | 3.8 | 4.6 |
| Example 1 | | | | |

5-point scale: 1=very poor, 2=poor, 3=moderate, 4=good, 5=very good.

### Example 7

### Preparation of Various Gluten-Free Rice Cookies

Various rice cookies were prepared using the rice cookie dough composition of Example 6.

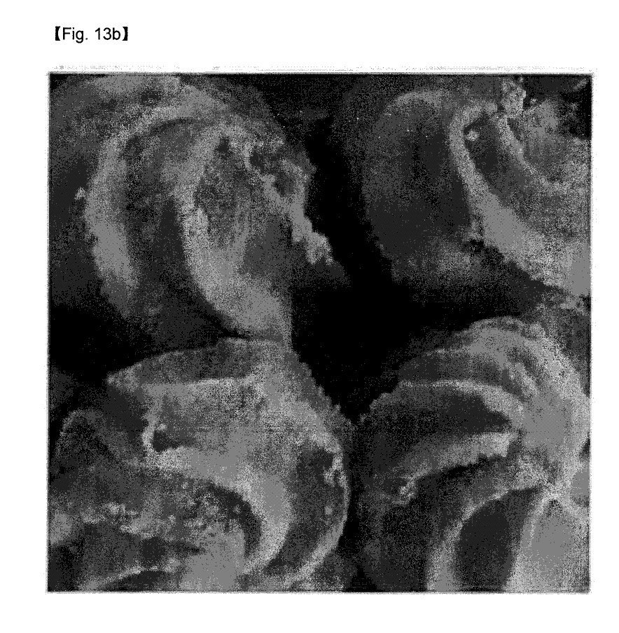

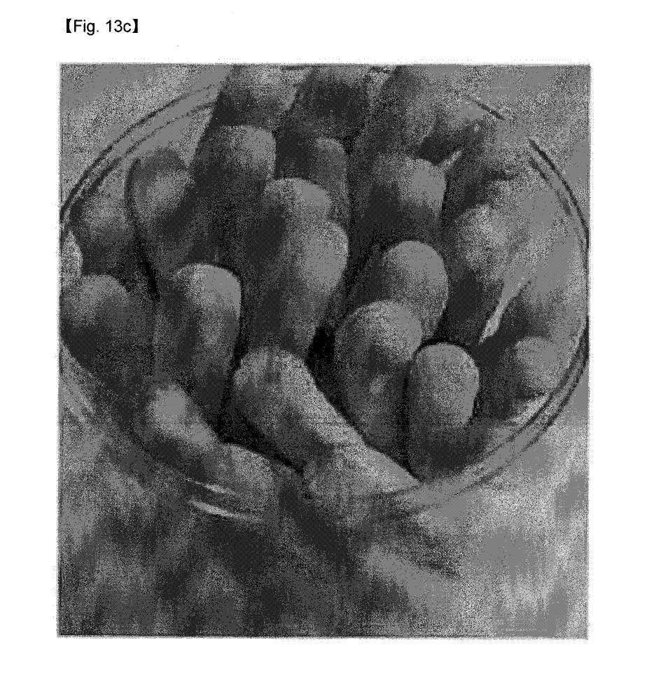

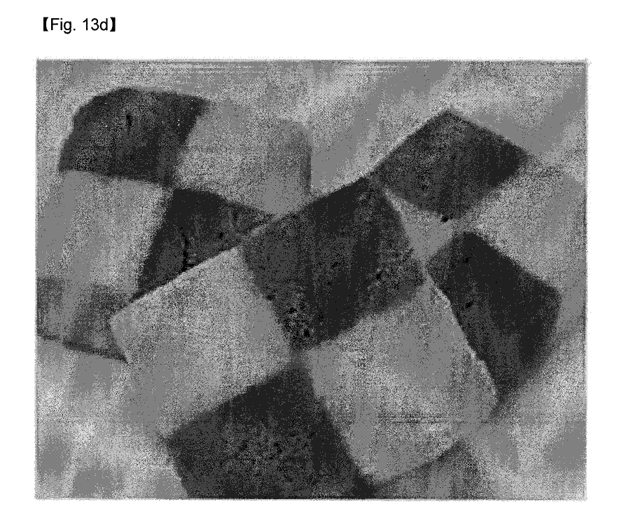

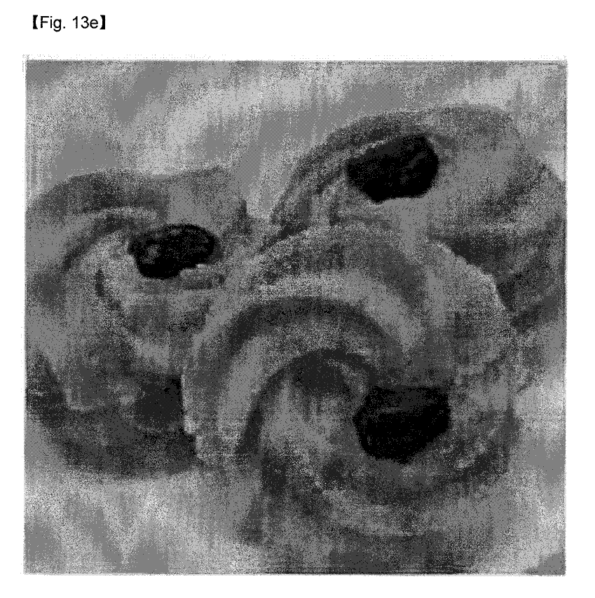

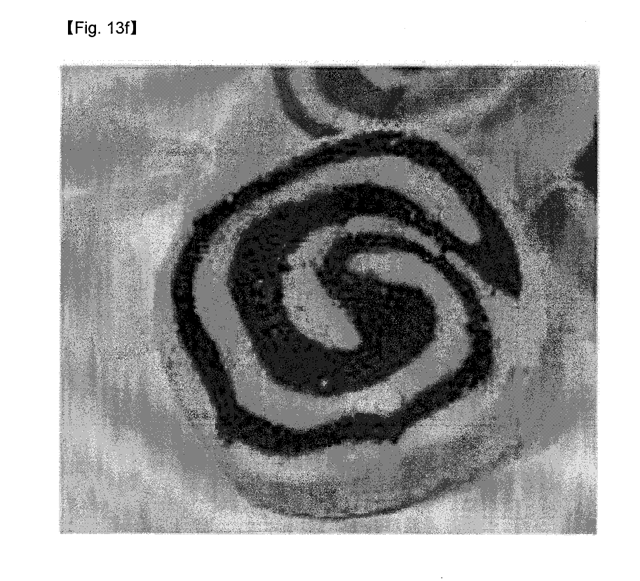

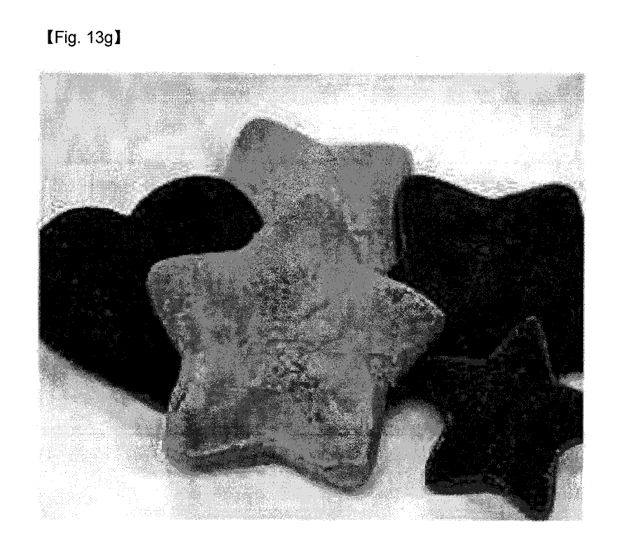

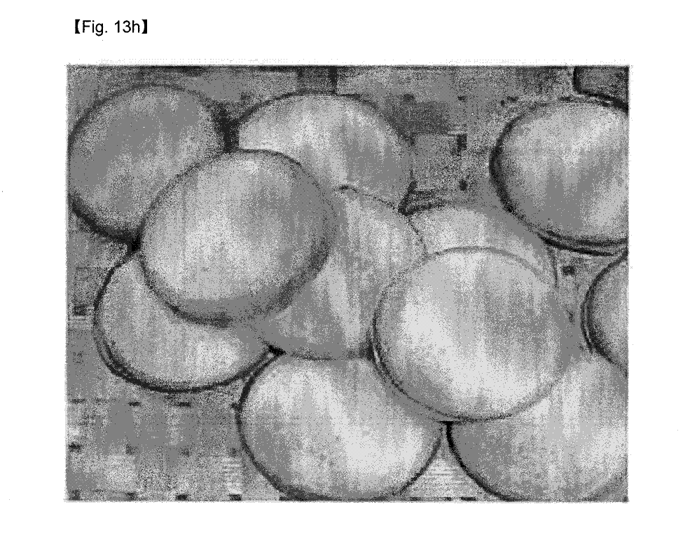

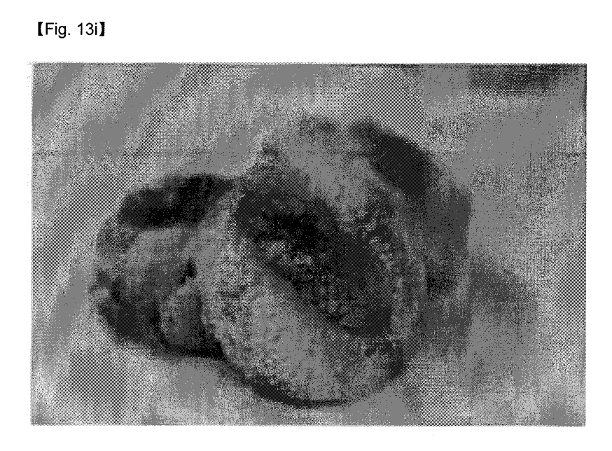

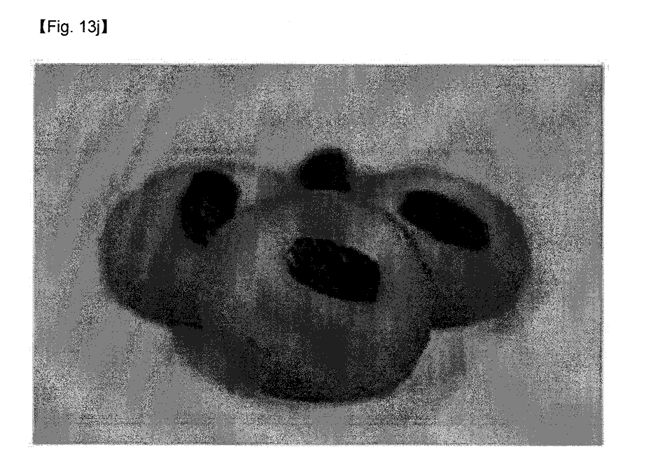

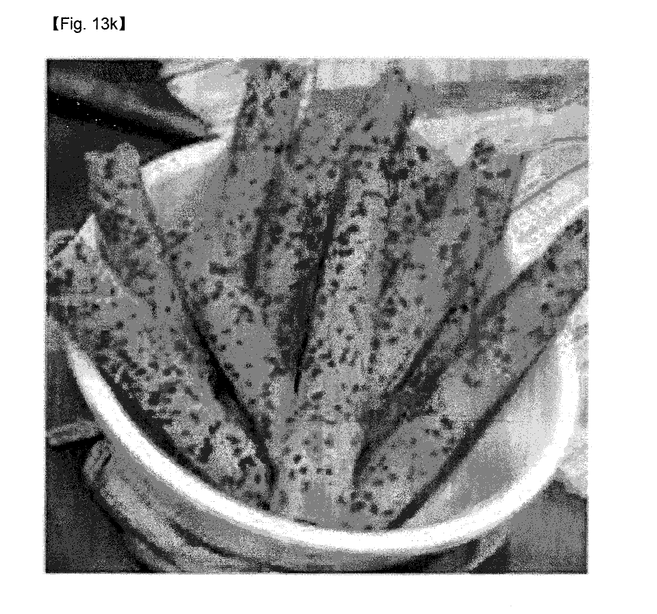

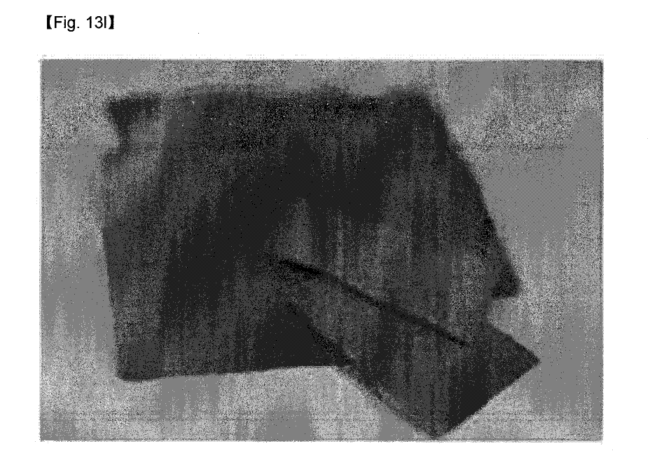

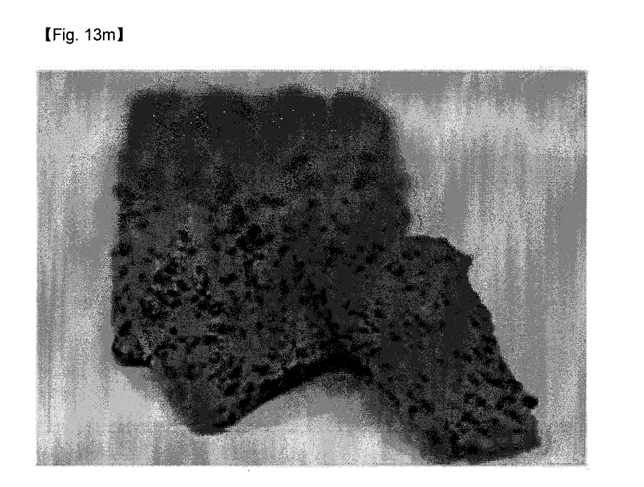

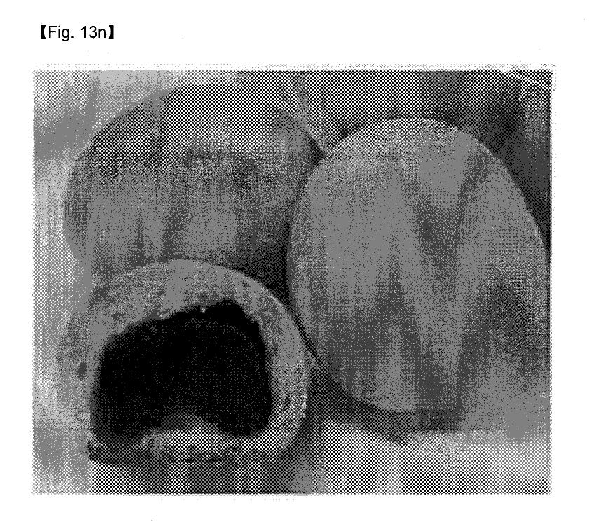

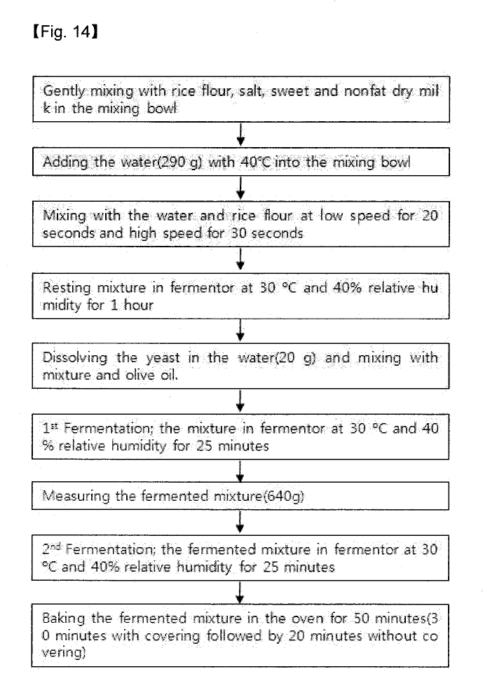

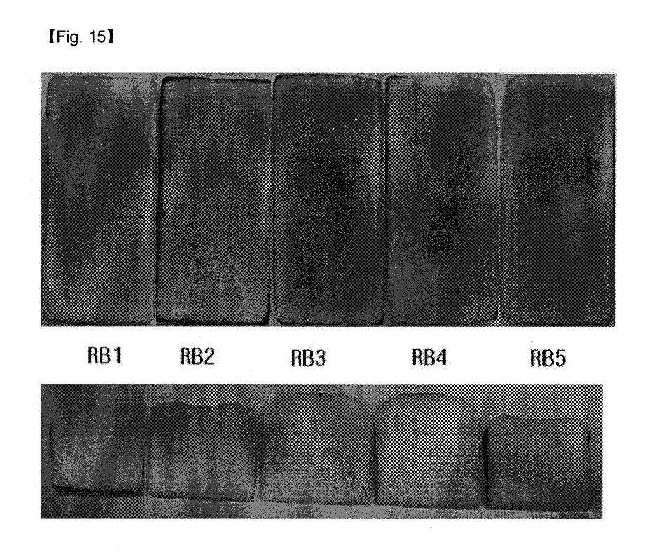

Polished rice citron shell cookie (FIG. 13a) was prepared by further adding 50 parts by weight of shortening and 40 parts by weight of citron jam to the basic composition. Bamboo leaf rice cookie (FIG. 13b) was prepared by further adding 50 parts by weight of shortening and 7 parts by weight of bamboo leaf powder to the basic composition. Polished rice stick cookie (43c) was prepared by adding 40 parts by weight of shortening to the basic composition instead of butter. Sweet potato mosaic rice cookie (FIG. 13d) was prepared by further adding 12 parts by weight of violet sweet potato powder to the basic composition. Cinnamon rice cookie (FIG. 13e) was prepared by further adding 2 parts by weight of cinnamon powder to the basic composition. Rice marble cookie (FIG. 13f) was prepared by further adding 40 parts by weight of cocoa powder to the basic composition. (Star-) shaped cookie (FIG. 13g) was prepared by further adding 50 parts by weight of dairy cream to the basic composition. Polished rice tiramisu cookie (FIG. 13h) was prepared by sanding with tiramisu cream prepared by mixing 5 parts by weight of coffee, 5 parts by weight of Kahlua, 150 parts by weight of cream cheese and 10 parts by weight of brown sugar. Rice walnut cookie (FIG. 13i) was prepared by using 150 parts by weight of almond flour, 50 parts by weight of sugar and half-cut walnut as topping. Polished rice cranberry cookie (FIG. 13j) was prepared by topping with dried cranberry. Bamboo leaf/shoot tulle (FIG. 13k) was prepared further by adding 100 parts by weight of a mixture of sugar-preserved bamboo shoot, bamboo leaf powder and black sesame to the basic composition. Brown rice senbei (FIG. 13l) was prepared by adding brown rice flour instead of rice flour. Sesame senbei (FIG. 13m) was prepared by further adding 50 parts by weight of black sesame to the basic composition. Polished rice manju (FIG. 13n) was prepared by adding 1 part by weight of red bean paste to the basic composition.

### Example 8

### Preparation of Yeast-Fermented Gluten-Free Rice Bread

Materials and Preparation Method

Mixing proportions, preparation method and quality of rice bread prepared using rice flour, rice protein and germ oil without wheat flour and gluten were investigated. Rice flour was prepared by sufficiently immersing rice in water (6-10 hours), drying at low temperature (around 30° C.) to water content 12-13%, milling and then passing through a standard sieve of regular size.

In order to reduce immersion time and amount of wastewater, after adding 50% or water, rice was treated with an enzyme mixture cellulase, pectinase, xylanase and protease for 1-2 hours, washed with water, dried at low temperature, milled, passed through a sieve of 80-160 mesh, and used as rice flour sample.

Rice bread was prepared by with rice flour (100 g), salt (3 g), sugar (8 g), yeast (4 g, S.I. Lesaffre, France), nonfat dry milk (5 g), olive oil (7 g) and water (110-115 g) by adding transglutaminase (TGase; Ajinomoto, Japan) enzyme, TGase and protein (whey protein; CP International, USA) and rice protein (isolated from the lab), TGase, protein and alginate (Tic Gum, USA), or TGase, protein, alginate, HPMC (hydroxypropyl methylcellulose; Ronas Chemicals Ind., Taiwan) to the rice flour (100 g). Addition amount to the rice flour (100 g) was TGase 0.04 g, protein 1.7 g, alginate (AL) 0.3 g and HPMC 0.07 g.

Rice bread was prepared by mixing rice flour (300 g) with salt (6 g), sugar (24 g), nonfat dry milk (15 g) and TGase (0.12 g), adding water (290 g) and mixing at low speed for 20 seconds and then at high speed for 30 seconds, resting for 1 hour, and then mixing with yeast and olive oil. The resulting dough was fermented at 30° C. and 40% relative humidity (RH) for 25 minutes. After panning on a pan with 640 g per each, the dough was further fermented for 10 minutes under the same condition, and then baked for 50 minutes with upper portion at 210° C. and lower portion at 170° C.

Subsequently, TGase (0.12 g) and protein (6 g), TGase (0.12 g), protein (7 g) and alginic acid derivative (1.2 g) or TGase (0.12 g), protein (6 g), alginate (1.2 g) and HPMC (0.4 g) were added.

The viscosity of the dough was different with the additives. The addition of enzyme and alginic acid derivative resulted in increased viscosity.

The specific volume of the rice bread was improved significantly when enzyme and protein (RB3) or enzyme, protein and alginic acid derivative (RB4) were added as compared to the bread with no additive added (RB1) or one with enzyme only added (RB2). Air cell uniformity and aggregation were investigated to examine the internal structure of the bread. RB3 with enzyme and protein added was improved in volume but showed nonuniform internal texture. The bread with enzyme, protein and alginic acid derivative added (RB4) showed the best improvement in volume as well as good internal structure, with uniform air cells and little aggregation. However, moistness or springiness was low. The bread with HPMC further added (RB5) showed the best internal structure and texture although the volume decreased slightly.

Therefore, it can be seen that rice flour, water, yeast, sugar, salt, nonfat dry milk, olive oil, TGase, WP, AL and HPMC are important ingredients when preparing rice bread from 100% gluten-free rice flour.

The reason why whey protein and rice protein were selected is because they are less allergenic than other food proteins. Since whey protein may cause allergy in people who are sensitive to milk products, hypoallergenic rice protein was used together. As a result, specific volume was increased and better internal structure was formed.

When gelatinized rice flour was added up to 10%, the flavor, moistness and texture of the rice bread were improved. By replacing sugar entirely or partly with trehalose, the structure and quality of bread could be improved while reducing calorie. An appropriate kneading condition of the rice flour mixture was mixing at low speed for 20 seconds and then at high speed for 30 seconds, followed by resting for about 1 hour.

An appropriate fermentation condition was 30° C. and 40% RH. Appropriate fermentation time was 30 minutes for the first fermentation and 15 minutes for the second fermentation. Appropriate baking temperature was upper portion 210° C. and lower portion 170° C. Appropriate baking time was 30 minutes with covering followed by 20 minutes without covering.

The texture and quality of the yeast-fermented gluten-free rice bread were compared while varying additives. The additives are described in Table 27 and their mixing proportion is described in Table 28.

TABLE 27

| | Addition amount | |
|---|---|---|
| Additives | (% of rice flour) | Result |
| Transglutaminase | 0.02, 0.04, 0.06% | Determined as 0.04% after |
| (TGase) | | testing texture and |
| | | softness of rice bread |
| Protein (whey | 1.0, 1.5, 1.7, 2.0% | Determined as 1.7% after |
| and rice protein) | | volume, air cell uniformity |
| | | and texture of rice bread |
| Alginate (AL) | 0.1, 0.3, 0.5, 1.0% | Determined as 0.3% after |
| | | testing softness, crispness |
| | | and volume of rice bread |
| Hydroxypropyl | 0.05, 0.07, 0.1, 0.5% | Determined as 0.07% after |
| methylcellulose | | testing adhesiveness, volume |
| (HPMC) | | and texture similarity to |
| | | wheat flour bread |

TABLE 28

| | Basic | | | | | |
|---|---|---|---|---|---|---|
| | composition | Rice bread containing different additives (g) | | | | |
| Ingredients | (%) | RB1 | RB2 | RB3 | RB4 | RB5 |
| Rice flour | 100 | 300 | 300 | 300 | 300 | 300 |
| Water | 115 | 345 | 345 | 345 | 345 | 345 |
| Salt | 3 | 9 | 9 | 9 | 9 | 9 |
| Sugar | 8 | 24 | 24 | 24 | 24 | 24 |
| Yeast | 4 | 12 | 129 | 12 | 12 | 12 |
| Nonfat | 5 | 15 | 15 | 15 | 15 | 15 |
| dry milk | | | | | | |
| Olive oil | 7 | 21 | 21 | 21 | 21 | 21 |
| Transglu- | 0.04 | — | 0.12 | 0.12 | 0.12 | 0.12 |
| taminase | | | | | | |
| Whey (rice) | 1.7 | — | — | 5.1 | 5.1 | 5.1 |
| protein | | | | | | |
| Alginate | 0.3 | — | — | — | 0.9 | 0.9 |
| HPMC | 0.07 | — | — | — | — | 0.21 |

* HPMC: hydroxypropyl methylcellulose.
* RB1: rice bread containing only the basic composition.
* RB2: rice bread with 0.04% transglutaminase added to the basic composition.
* RB3: rice bread with1.7% whey (rice) protein (WP) added to RB2.
* RB4: rice bread with 0.3% alginate added to RB3.
* RB5: rice bread with 0.07% HPMC added to RB4.

Color Analysis of Dough

Various additives were added to the dough of the rice bread in the form of batter in order to establish the optimized condition. RB1 was the basic composition, RB2 had TGase (0.04% of rice flour) added to RB1, RB3 had WP (1.7% of rice flour) added to RB2, RB4 had AL (0.3% of rice flour) added to RB3, and RB5 had HPMC (0.07% of rice flour) added to RB4.

Hunter L (lightness), ±a (redness/greenness) and ±b (yellowness/blueness) values of the dough was measured 5 times with a colorimeter (Chroma Meter, CR-300, Minolta, Tokyo, Japan) and then averaged. The instrument was corrected for a standard white plate. L, a and b values were measured as 96.54, 0.07 and 1.90, respectively.

Gelatinization Characteristic of Dough

The gelatinization characteristic of rice flour, rice flour with TGase added, rice flour with TGase and WP (RP) added, rice flour with TGase, WP (RP) and AL added and rice flour with TGase, WP(RP), AL and HPMC added was investigated, with the same mixing proportions as described above. Measurement was made using Rapid Visco Analyzer (RVA, Model 3D, Newport Scientific Pty, Ltd, Narrabeen, Australia) according to the AACC Method 61-02. 3.0 g of sample (water content 12%) was held in a canister. After adding distilled water (25 mL) and mixing well, viscosity was measured while keeping at 50° C. from 0 to 1 minute, heating to 95° C. from 1 to 4.45 minutes, maintaining at 95° C. from 4.45 to 7.15 minutes, cooling to 50° C. from 7.15 to 11.06 minutes and maintaining at 50° C. from 11.06 to 12.30 minutes. The peak viscosity (P), tough viscosity (T), and cold viscosity (C) at 50° C. were measured. Then, setback viscosity (C−T) and breakdown viscosity (P−T) were calculated.

### Example 9

### Quality Evaluation of Yeast-Fermented Gluten-Free Rice Bread

Evaluation Method

(1) General Composition

Rice bread prepared using different additives was freeze-dried using a freeze-dryer (IIshin, Korea), pulverized and passed through a 100-mesh sieve for use as a test sample. The general composition of the rice bread was measured by the AOAC method (2000). Water content was measured after drying in an oven under normal pressure. Protein content was analyzed using a Kjeldahl nitrogen analyzer (J.P. Selecta), crude lipid was analyzed by the Soxhlet method using ether as solvent. Ash content was measured by the direct ashing method using an ashing furnace at 550° C. All the measurements were made at least 2 times.

(2) Weight and Volume

Weight of the rice bread was measured after cooling at room temperature for 4 hours. Volume was measured according to the AACC Method 72-10 using hulled millet. First, hulled millet was filled in a pan in which the rice bread can be held, and the volume of the hulled millet was measured using a volumetric flask (a). After putting the rice bread on the same pan and filling the remaining space with hulled millet, the volume of the added hulled millet was measured (b). Then, the volume (mL) of the rice bread was calculated from a−b. Specific volume of the rice bread was calculated by the following equation.

Specific volume=Volume (mL)/Weight (g)

(3) Shape

Overall shape and cross-section of the rice bread cooled at room temperature for 4 hours were observed using a digital camera (Kenko, Canon, Tokyo. Japan). Surface shape and color and crumb shape were observed.

(4) Air Cell

Air cell and structure of the rice bread were observed under a microscope (Sometech Jison, Seoul, Korea) along the cross-section. Microscopic observation was made at ×40, with 30 mm distance from the object, and camera knob position.

(5) Color

Color of the rice bread was analyzed using a colorimeter (Chroma Meter CR-300, Minolta, Tokyo, Japan). Hunter's L (lightness), ±a (redness/greenness) and ±b (yellowness/blueness) values were measured 5 times and then averaged. Instrument calibration was performed using a standard white plate with L=96.54, a=0.07 and b=1.90.

(6) Texture

The crumb of the rice bread was cut to a cube of 1 cm³ and texture profile analysis (TPA) was carried out by the repeated compression test using a texture analyzer (TA-XT Plus England) while keeping in Ziploc (Johnson, USA) to prevent evaporation of moisture. Measurement was made 10 times per sample. From the obtained TPA curve, hardness, cohesiveness, springiness, adhesiveness, chewiness, gumminess and resilience were compared.

TABLE 29

| Instrument | Texture analyzer (TA-XT plus) |
|---|---|
| Test type | TPA (two bite compression test) |
| Probe type | Cylinder (Φ15 mm) |
| Sample size | 1 × 1 × 1 cm³ |
| Strain | 80% |

(7) Sensation Test

Sensation test of the rice bread was performed using a questionnaire to investigate difference and preference. Panels who were majoring in food and nutrition in graduate schools were told of the purpose of the sensation test and trained repeatedly before testing. Surface color, smoothness, inside color, air cell uniformity and degree of swelling of the rice bread were examined as appearance items. In addition smell and, as texture items, hardness, adhesiveness, springiness, chewiness, moistness and softness were examined. Each test item was scored from 1 (worst) to 9 (best).

(8) Statistical Analysis

All the experiment was repeated at least twice. Statistical analysis was carried out by ANOVA using the SAS package (version 8.1). Statistical significance of difference was analyzed at p<0.05 by the Duncan's multiple range test.

Evaluation Result

(1) General Composition

Water content of the rice bread was measured after cooling at room temperature for 4 hours. Protein, crude lipid and ash contents after freeze-drying are shown in Table 30. Water content of RB1-RB5 was almost identical, from 46.68-47.70%. Protein content of RB1 and RB2 was not significantly different, with 7.79-7.78%. Protein content of RB3-RB5 was 8.65-8.73%. It is thought as the result of enzyme-assisted crosslinkage of WP. Crude lipid content was identical as 5.7% for RB1 and RB2 and similar for RB3 (5.15%) and RB4 and RB5 (5.07%). The addition of additives may have caused the decrease of the crude lipid content. Since RB5 and RB4 have the same crude lipid content, it is thought that the addition of HPMC in small amount does not have a significant effect. Ash content was the same for RB1-RB5 as 0.02%. In Table 30, values with different superscripts in the same column are significantly different at p<0.05.

TABLE 30

| Sample | Water (%) | Protein (%) | Crude lipid (%) | Ash (%) |
|---|---|---|---|---|
| RB1 | 46.68 ± 0.06^{b1)} | 7.79 ± 0.09^{b} | 5.37 ± 0.08^{a} | 0.02 ± 0.00 |
| RB2 | 47.66 ± 0.32^{a} | 7.78 ± 0.00^{b} | 5.37 ± 0.04^{a} | 0.02 ± 0.00 |
| RB3 | 46.70 ± 0.05^{b} | 8.67 ± 0.08^{a} | 5.15 ± 0.08^{b} | 0.02 ± 0.00 |
| RB4 | 46.69 ± 0.10^{b} | 8.73 ± 0.07^{a} | 5.07 ± 0.06^{b} | 0.02 ± 0.00 |
| RB5 | 47.55 ± 0.02^{a} | 8.65 ± 0.02^{a} | 5.07 ± 0.07^{b} | 0.02 ± 0.00 |

(2) Weight and Volume

Weight and volume of the rice bread containing different additives are shown in Table 31. Volume of RB1 (control) was smallest as 840 mL and RB2 with TGase added was swollen more by about 10% to 930 mL. Volume of RB3 with TGase and WP added was 1110 mL, and that of RB4 with AL further added was 1132.5 mL. When HPMC was added to give the rice bread a texture similar to that of wheat flour (RB5), the volume was decreased to 945 mL. Specific volume was the largest for RB4. In Table 5, values with different superscripts in the same column are significantly different at p<0.05.

TABLE 31

| Sample | Weight (g) | Volume (mL) | Specific volume (mL/g) |
|---|---|---|---|
| RB1 | 570 ± 0.7 | 842.5 ± 10.6^{c1)} | 1.48 |
| RB2 | 576 ± 2.8 | 930.0 ± 14.1^{b} | 1.61 |
| RB3 | 572 ± 1.4 | 1110.0 ± 14.1^{a} | 1.94 |
| RB4 | 573 ± 0.7 | 1132.5 ± 17.7^{a} | 1.98 |
| RB5 | 585 ± 0.7 | 945.0 ± 7.1^{b} | 1.62 |

(3) Shape

Overall appearance and cross-sectional shape of the rice bread are shown in FIG. 15. The volume of RB2-RB5 was larger than that of the control. After being taken out of the pan, RB1-RB3 showed some surface cracks. RB1 and RB2 showed slight dents at the upside as well as severe cracking. RB3 showed cracking at the upside but had a good appearance. RB4 and RB5 showed smooth surface and right shape without little cracking at the upside. However, RB5 showed dent after swelling, indicating that the bread structure is less stable. From the cross-sectional examination, formation of crumb structure could be identified. RB1 and RB2 showed aggregation at the bottom portion of the bread without formation of air cells. When compared with RB3 and RB4 showing large volume increase, RB3 lacked air cells or had air cells of nonuniform size at the bottom portion. In contrast, RB5 had a slightly smaller volume but showed stabilized air cells and structure like RB4, as well as increased moistness. Specific volume of RB1, RB2, RB3, RB4 and RB5 was 1.48, 1.61, 1.94, 1.98 and 1.62, respectively. The specific volume of RB3 and RB4 was 1.94 and 1.98, large for rice bread, whereas RB5 that exhibited good overall quality had a small specific volume of 1.62.

From the comparison of RB4 and RB5, it can be seen that the addition of HPMC results in reduced volume and improved texture. It is thought that HPMC results in volume increase by increasing water absorption.

(3) Air Cell

The result of observing the cross-sectional structure of the rice bread using an optical microscope is shown in FIG. 15. RB1 showed a lot of aggregation and the air cells were not round but prolate horizontally. RB2 showed irregular air cells. Large air cells were found at the top portion. RB3 had a number of large air cells but they were aggregated with each other. RB4 had large air cells as well as a number of small air cells that were aggregated with each other. RB5 showed air cells similar to those of bread and had less aggregation. To conclude, RB5 had an internal structure similar to that of wheat flour bread, with moist and springy cross-section. That is to say, the rice bread containing all the four additives showed the best quality.

(4) Color

As seen from Table 6, redness of the rice bread was almost similar as −2.01 to −2.58. Lightness was almost for RB1 and RB2, higher for RB3 and RB4 as 77.26-77.82, and slightly less for RB5, as compared to the control. Yellowness was almost for RB1 and RB2, and slightly higher for RB3, RB4 and RB5. There was no great difference in redness and yellowness, but significant difference was found between samples. It is though that the difference is owing to the difference in air cell uniformity and aggregation rather than the additives. In Table 32, values with different superscripts in the same column are significantly different at p<0.05.

TABLE 32

| Sample | L | a | b |
|---|---|---|---|
| RB1 | 74.53 ± 0.10 | −2.58 ± 0.06^{c1)} | 8.81 ± 0.24^{c} |
| RB2 | 75.14 ± 1.98 | −2.01 ± 0.09^{a} | 8.74 ± 0.37^{c} |
| RB3 | 77.26 ± 1.73 | −2.06 ± 0.05^{a} | 9.19 ± 0.34^{bc} |
| RB4 | 77.82 ± 3.09 | −2.13 ± 0.11^{a} | 9.63 ± 0.50^{ab} |
| RB5 | 73.05 ± 0.67 | −2.34 ± 0.19^{b} | 9.92 ± 0.69^{a} |

(5) Texture

Hardness, springiness, adhesiveness and cohesiveness as primary factors and gumminess and resilience as secondary factors of the texture of rice bread are shown in Table 33. Springiness and gumminess were highest for RB5 but cohesiveness and resilience were highest for RB4. The secondary factors were better for RB4 and RB5 than other samples. They are considered to greatly affect the quality of bread. RB4 had higher cohesiveness and resilience than RB5. RB5 showed higher springiness and gumminess than other bread samples. Thus, it can be concluded that RB5 has structure and texture similar to those of general bread. In Table 33, values with different superscripts in the same column are significantly different at p<0.05.

TABLE 33

| Sample | Hardness | Adhesiveness | Springiness | Cohesiveness | Gumminess | Resilience |
|---|---|---|---|---|---|---|
| RB1 | 437.6 ± 41.2^{c1)} | −10.64 ± 2.45^{a} | 0.20 ± 0.01^{e} | 0.43 ± 0.04^{cd} | 186.90 ± 29.60^{d} | 0.13 ± 0.02^{c} |
| RB2 | 974.9 ± 146.9^{b} | −135.03 ± 55.10^{c} | 0.34 ± 0.04^{d} | 0.41 ± 0.06^{d} | 389.26 ± 18.69^{c} | 0.12 ± 0.03^{c} |
| RB3 | 834.1 ± 238.1^{b} | −89.66 ± 34.76^{b} | 0.42 ± 0.04^{c} | 0.47 ± 0.06^{c} | 381.82 ± 77.01^{c} | 0.15 ± 0.02^{c} |
| RB4 | 813.7 ± 201.3^{b} | −12.45 ± 5.92^{a} | 0.48 ± 0.03^{b} | 0.73 ± 0.03^{a} | 587.88 ± 125.23^{b} | 0.37 ± 0.04^{a} |
| RB5 | 1308.4 ± 212.0^{a} | −21.79 ± 6.66^{a} | 0.52 ± 0.01^{a} | 0.62 ± 0.04^{b} | 804.71 ± 126.39^{a} | 0.30 ± 0.03^{b} |

(6) Sensation Test

Sensation test of the rice bread was performed using a questionnaire to investigate difference and preference. Surface color, surface smoothness, air cell uniformity, volume, smell, hardness, adhesiveness, springiness, chewiness and softness showed significant difference depending on additives. Higher surface color, surface smoothness, air cell uniformity, volume, springiness, chewiness and softness were observed as the number of additives increased (Tables 34 and 35). Smell decreased as the number of additives increased. Hardness was high for RB1 and similar in other samples. Adhesiveness was very high for RB1 and slightly low for RB2, RB3 and RB4. RB5 with HPMC added showed very low adhesiveness (2.5), suggesting that bread-like texture is achieved with low adhesiveness. Table 36 shows the result of preference examination. Significant difference (p<0.05) was observed in all the 5 items. Preference increased as the number of additives increased. RB4 scored 8.1 and RB5 scored 8.6 out of 9. RB4 scored well in appearance. Although texture and preference were slightly lower than RB5, the difference was not significant. RB5 scored well in all test items as well as in overall quality. In Tables 34-36, values with different superscripts in the same column are significantly different at p<0.05.

TABLE 34

| | Appearance | | | | | |
|---|---|---|---|---|---|---|
| | | | | Air cell | | |
| Sample | Surface Color | Smoothness | Crumb Color | uniformity | Volume | Smell |
| RB1 | 3.2 ± 1.0^{c1)} | 4.4 ± 1.7^{c} | 6.4 ± 1.4 | 3.1 ± 1.5^{c} | 3.0 ± 0.8^{c} | 3.1 ± 1.2^{a} |
| RB2 | 4.8 ± 1.1^{b} | 3.2 ± 1.7^{c} | 6.1 ± 1.6 | 3.7 ± 1.1^{bc} | 3.6 ± 1.2^{c} | 2.0 ± 0.7^{c} |
| RB3 | 7.1 ± 1.6^{a} | 4.0 ± 1.4^{c} | 6.5 ± 1.5 | 4.5 ± 1.3^{b} | 8.0 ± 0.9^{a} | 1.3 ± 0.5^{b} |
| RB4 | 6.5 ± 1.3^{a} | 6.3 ± 1.6^{b} | 6.8 ± 1.1 | 6.2 ± 1.3^{a} | 8.0 ± 0.5^{a} | 1.7 ± 0.7^{b} |
| RB5 | 6.1 ± 1.7^{a} | 8.5 ± 0.5^{a} | 7.5 ± 1.1 | 6.8 ± 1.3^{a} | 7.1 ± 0.9^{b} | 1.3 ± 0.7^{b} |

TABLE 35

| | Taste | | | | | |
|---|---|---|---|---|---|---|
| Sample | Hardness | Adhesiveness | Springiness | Chewiness | Moistness | Softness |
| RB1 | 5.8 ± 1.0^{a} | 7.8 ± 1.4^{a} | 4.1 ± 1.9^{c} | 3.7 ± 1.8^{c} | 5.5 ± 1.3 | 4.9 ± 1.9^{c} |
| RB2 | 4.1 ± 1.4^{b} | 5.0 ± 1.6^{b} | 5.0 ± 1.4^{bc} | 4.8 ± 1.8^{bc} | 6.1 ± 1.3 | 5.5 ± 1.3^{c} |
| RB3 | 3.7 ± 1.2^{b} | 6.1 ± 1.6^{b} | 5.4 ± 1.3^{abc} | 5.1 ± 1.2^{bc} | 6.1 ± 1.3 | 6.1 ± 0.9^{bc} |
| RB4 | 4.1 ± 1.0^{b} | 5.0 ± 1.2^{b} | 6.5 ± 1.7^{ab} | 5.8 ± 1.8^{ab} | 5.6 ± 1.4 | 7.1 ± 1.1^{ab} |
| RB5 | 4.3 ± 2.1^{b} | 2.5 ± 1.4^{c} | 6.7 ± 1.9^{a} | 7.2 ± 1.6^{a} | 6.4 ± 1.4 | 7.4 ± 1.4^{a} |

TABLE 36

| Sam- | | | | | |
|---|---|---|---|---|---|
| ple | Appearance | Smell | Taste | Texture | Preference |
| RB1 | 3.3 ± 0.9^{c1)} | 5.8 ± 1.1^{c} | 3.0 ± 1.7^{d} | 2.9 ± 1.7^{c} | 2.9 ± 1.8^{c} |
| RB2 | 2.8 ± 1.3^{c} | 6.1 ± 0.9^{bc} | 4.4 ± 0.8^{c} | 4.9 ± 0.9^{b} | 4.1 ± 1.5^{bc} |
| RB3 | 5.5 ± 1.4^{b} | 6.2 ± 1.2^{bc} | 5.4 ± 0.5^{b} | 4.7 ± 1.3^{b} | 5.2 ± 1.5^{b} |
| RB4 | 7.4 ± 1.1^{a} | 7.1 ± 1.6^{ab} | 7.8 ± 0.8^{a} | 7.7 ± 0.7^{a} | 8.1 ± 0.9^{a} |
| RB5 | 8.1 ± 0.9^{a} | 7.5 ± 1.6^{a} | 8.4 ± 0.8^{a} | 8.6 ± 1.1^{a} | 8.6 ± 0.5^{a} |

### Example 10

### Establishment of Mixing Proportions and Preparation Process of Yeast-Fermented Gluten-Free Rice Bread

From the above study on the four additives for improvement of the quality of yeast-fermented gluten-free rice bread, the mixing proportions and preparation process of rice bread were established.

In addition, optimized addition condition of rice germ oil, gelatinized rice flour and trehalose instead of olive oil in order to improve surface color and structure and reduce calorie was established.

Basically, rice bread comprised rice flour (100 g), salt (3 g), yeast (4 g), nonfat dry milk (5 g), olive oil (7 g) or rice bran oil (brown rice germ oil) (7 g), water (110-115 g), sugar (8 g), rice protein (1.7 g), transglutaminase (0.04 g), alginate (0.3 g) and HPMC (0.07 g).

Rice protein is obtained while starch is isolated from rice (normal rice, ground rice or old rice) by alkaline precipitation and has little color or odor.

Replacing sugar in part with trehalose results in reduced calorie, decreased browning and development of small and uniform air cells in the bread.

And, addition of gelatinized rice flour or gelatinized starch in an amount of 0-10% makes the bread texture softer and moister.

In order to investigate the effect of addition of trehalose and gelatinized rice flour, rice bread was prepared from the following 4 samples. Then, volume and texture were evaluated by sensation test. Sample 1: rice flour (95)+gelatinized rice flour (5, prepared from the lab)+trehalose (3, Samyang Genex)+sugar (3), sample 2: rice flour (100)+trehalose (3)+sugar (3), sample 3: rice flour (95)+gelatinized rice flour (5)+sugar (6), sample 4: rice flour (100)+sugar (6).

Specific volume was not significantly different among sample 4 (basic composition, 1.79), sample 3 with 5% gelatinized rice flour added thereto (1.76), sample 2 with 3% trehalose and 3% sugar added to rice flour (1.69) and sample 1 with gelatinized rice flour further added thereto (1.68). The bread prepared using sugar had a larger specific volume than one in which trehalose partly replaced sugar.

The result of sensation is as follows.

TABLE 37

| Sam- | Appearance | | | Internal structure | |
|---|---|---|---|---|---|
| ple | Surface color | Smoothness | Volume | Color | Air cell uniformity |
| 1 | 6.0 | 6.3 | 5.8 | 5.7 | 7.7 |
| 2 | 5.2 | 7.8 | 6.3 | 6.2 | 7.5 |
| 3 | 6.3 | 4.8 | 7.0 | 6.7 | 5.8 |
| 4 | 5.5 | 5.2 | 6.3 | 6.2 | 5.8 |

TABLE 38

| | | Texture | | | | | |
|---|---|---|---|---|---|---|---|
| Sam- | | Hard- | Adhesive- | Springi- | Chewi- | Moist- | Soft- |
| ple | Smell | ness | ness | ness | ness | ness | ness |
| 1 | 6.8 | 6.0 | 2.5 | 6.8 | 7.2 | 7.8 | 7.0 |
| 2 | 6.0 | 6.3 | 2.7 | 7.0 | 7.4 | 6.7 | 6.5 |
| 3 | 5.0 | 5.0 | 3.2 | 7.2 | 7.0 | 7.8 | 7.0 |
| 4 | 4.3 | 6.3 | 2.5 | 7.0 | 6.3 | 6.8 | 7.8 |

The bread with gelatinized rice flour and sugar added exhibited stronger color. Air cell uniformity was better when trehalose was added. Smell was stronger when trehalose was added. All the bread showed good texture quality, with low adhesiveness and high springiness.

TABLE 39

| Sample | Appearance | Smell | Taste | Texture | Overall preference |
|---|---|---|---|---|---|
| 1 | 6.8 | 6.0 | 6.7 | 6.3 | 6.5 |
| 2 | 7.0 | 6.7 | 7.0 | 6.5 | 7.5 |
| 3 | 7.2 | 7.5 | 8.0 | 7.3 | 7.5 |
| 4 | 6.8 | 7.5 | 7.5 | 7.8 | 7.8 |

* 9-point scale: higher scores mean better preference.

The addition of sugar resulted in better smell owing to browning. Taste was better when gelatinized rice flour and sugar were added together. Texture was better when only sugar was added. Overall preference was the best for the bread prepared only with the basic composition. Among those with gelatinized rice flour, trehalose and sugar added, the bread with no gelatinized rice flour added was better in overall preference. It was confirmed that rice bread products with various quality can be developed by adding various additives to the basic composition.

Those skilled in the art will appreciate that the conceptions and specific embodiments disclosed in the foregoing description may be readily utilized as a basis for modifying or designing other embodiments for carrying out the same purposes of the present disclosure. Those skilled in the art will also appreciate that such equivalent embodiments do not depart from the spirit and scope of the disclosure as set forth in the appended claims.

1. A wet rice noodle composition comprising nonglutinous rice, isolated soy protein and gum as main ingredients.

2. The wet rice noodle composition of claim 1, which further comprises protein-crosslinking enzyme.

3. The wet rice noodle composition of claim 1, wherein the gum is an alginic acid derivative.

4. The wet rice noodle composition of claim 2, wherein the enzyme is transglutaminase forming crosslinking bonds.

5. A method for preparing wet rice noodle wherein rice flour prepared by screening, washing with water, immersing in water, drying and milling nonglutinous rice, which is then dried, or by drying rice grain at low temperature and milling is mixed with isolated soy protein, kneaded by adding gum and water, rested at 40° C. for 1 hour, prepared into noodle by passing through a noodle-making machine, and cut into regular size.

6. A composition for preparing gluten-free rice cake comprising 70-200 parts by weight of rice flour, 100-300 parts by weight of egg, 40-120 parts by weight of sweet, 5-40 parts by weight of vegetable oil, 0.1-3 parts by weight of salt and 5-40 parts by weight of fermented grain liquor.

7. The composition for preparing gluten-free rice cake of claim 6, wherein the rice flour is prepared by immersing rice in water for 2-15 hours, drying at low temperature of 5-35° C. and then milling, or by immersing rice in water for 2-15 hours, milling and then drying at low temperature of 5-35° C.

8. The composition for preparing gluten-free rice cake of claim 6, wherein the rice flour has a water content of 5-20%.

9. The composition for preparing gluten-free rice cake of claim 6, wherein the rice flour has a particle size of 50-200 μm.

10. The composition for preparing gluten-free rice cake of claim 6, wherein the rice flour is flour of one or more selected from a group consisting of glutinous rice, nonglutinous rice, brown rice, germinated brown rice and black rice.

11-12. (canceled)

13. The composition for preparing gluten-free rice cake of claim 6, wherein the fermented grain liquor is one or more selected from a group consisting of makgeolli, dongdongju, cheongju, yakju and beer.

14. The composition for preparing gluten-free rice cake of claim 6, wherein the rice cake is rice cup cake, rice roll cake, rice chiffon cake, castella, steamed rice cake, rice cheesecake, rice sponge cake, muffin or rice pound cake.

15. Gluten-free rice cake comprising 70-200 parts by weight of rice flour, 100-300 parts by weight of egg, 40-120 parts by weight of sweet, 5-40 parts by weight of vegetable oil, 0.1-3 parts by weight of salt and 5-40 parts by weight of fermented grain liquor.

16. A method for preparing gluten-free rice cake, comprising:
(a) mixing 100-300 parts by weight of egg, 40-120 parts by weight of sweet and 0.1-3 parts by weight of salt:
(b) mixing the mixture resulting from the step (a) with 70-200 parts by weight of rice flour, 5-40 parts by weight of vegetable oil and 5-40 parts by weight of fermented grain liquor and kneading; and
(c) heating the mixture dough resulting from the step (b) to 120-200° C. to prepare gluten-free rice cake.

17-18. (canceled)

19. The method for preparing gluten-free rice cake of claim 16, wherein the step (a) comprises heating in a water bath of 35-50° C.

20. The method for preparing gluten-free rice cake of claim 16, wherein the rice flour is prepared by immersing rice in water for 2-15 hours, drying at low temperature of 5-35° C. and milling or by immersing rice in water for 2-15 hours, milling and drying at low temperature of 5-35° C.

21. The method for preparing gluten-free rice cake of claim 16, wherein the rice flour in the step (b) is flour of one or more selected from a group consisting of glutinous rice, nonglutinous rice, brown rice, germinated brown rice and black rice.

22. The method for preparing gluten-free rice cake of claim 16, wherein the rice flour has a water content of 5-20%.

23. The method for preparing gluten-free rice cake of claim 16, wherein the rice flour in the step (b) has a particle size of 50-200 μm.

24. The method for preparing gluten-free rice cake of claim 16, wherein the fermented grain liquor in the step (b) is one or more selected from a group consisting of makgeolli, dongdongju, cheongju, yakju and beer.

25. The method for preparing gluten-free rice cake of claim 16, wherein the step (b) further comprises, after mixing the mixture dough prepared in the step (a) with rice flour, resting at 15-30° C. for 5-50 minutes.

26. The method for preparing gluten-free rice cake of claim 16, wherein the rice cake is rice cup cake, rice roll cake, rice chiffon cake, castella, steamed rice cake, rice cheesecake, rice sponge cake, muffin or rice pound cake.

27-90. (canceled)
